(19) United States
(12) Patent Application Publication
(10) Pub. No.: US 2023/0072379 A1
(43) Pub. Date: Mar. 9, 2023

(54) UE-TO-UE COMMUNICATION OF DISPARATE TRAFFIC TYPES OVER ONE OR MORE UNICAST LINKS

(71) Applicant: QUALCOMM Incorporated, San Diego, CA (US)

(72) Inventors: Hong CHENG, Bridgewater, NJ (US); Dan VASSILOVSKI, Del Mar, CA (US); Karthika PALADUGU, San Diego, CA (US); Lan YU, Beijing (CN)

(21) Appl. No.: 17/760,183

(22) PCT Filed: Feb. 7, 2020
(86) PCT No.: PCT/CN2020/074545

§ 371 Date: Aug. 4, 2022

(51) Int. Cl. H04W 76/12; H04W 28/02; H04W 76/25

(52) U.S. Cl. CPC H04W 76/12; H04W 28/0268; H04W 76/25; H04W 92/18

(57) ABSTRACT

In an aspect, a first UE communicates (e.g., transmits and/or receives) traffic of a first type with a second UE via a unicast link. The first UE sets up support for transport of traffic of a second type over the unicast link. The first UE tunnels (e.g., transmits and/or receives) the traffic of the second type between the first UE and the second UE over the unicast link. In another aspect, instead of tunneling the traffic of the second type over the same unicast link, the first UE sets up a second unicast link for traffic of the second type with the second UE, with the unicast links having a shared link management status. In another aspect, a BS allocates a set of resources to support the associated (e.g., bound) unicast link.

### INTRODUCTION

Various aspects described herein generally relate to wireless communication systems, and more particularly, to transporting data over sidelinks.

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

A fifth generation (5G) mobile standard, also referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor, for example. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Leveraging the increased data rates and decreased latency of 5G, among other things, Vehicle-to-Everything (V2X) communication technologies are being implemented to support autonomous driving applications, such as wireless communications between vehicles, between vehicles and the roadside infrastructure, between vehicles and pedestrians, etc.

### SUMMARY

This summary identifies features of some example aspects, and is not an exclusive or exhaustive description of the disclosed subject matter. Whether features or aspects are included in, or omitted from this summary is not intended as indicative of relative importance of such features. Additional features and aspects are described, and will become apparent to persons skilled in the art upon reading the following detailed description and viewing the drawings that form a part thereof.

An aspect is directed to a method of operating a first user equipment (UE), comprising communicating traffic of a first type with a second UE via a unicast link, setting up support for transport of traffic of a second type over the unicast link, and tunneling the traffic of the second type between the first UE and the second UE over the unicast link.

Another aspect is directed to a method of operating a first user equipment (UE), comprising communicating traffic of a first type with a second UE via a first unicast link, setting up, with the second UE, a second unicast link associated with traffic of a second type, associating the first and second unicast links together with a shared link management status, communicating the traffic of the second type with the second UE via the second unicast link, and maintaining the shared link management status of the first and second unicast links based on the communicated traffic on any of the first and second unicast links.

Another aspect is directed to a method of operating a base station, comprising receiving, from a first user equipment (UE) that has already setup a first unicast link with a second UE for communication of traffic of a first type, a request for resources in association with link establishment of a second unicast link with the second UE for communication of traffic of a second type, determining that the first and second unicast links are to be associated with a shared link management status, determining a set of resources to support the second unicast link between the first UE and the second UE based at least in part upon the shared link management status determined for the first and second unicast links, and sending, to the first UE, an indication of the set of resources.

Another aspect is directed to a first user equipment (UE), comprising a memory, at least one transceiver, and at least one processor communicatively coupled to the memory and the at least one transceiver, the at least one processor configured to communicate traffic of a first type with a second UE via a unicast link, setup support for transport of traffic of a second type over the unicast link, and tunnel the traffic of the second type between the first UE and the second UE over the unicast link.

Another aspect is directed to a first user equipment (UE), comprising a memory, at least one transceiver, and at least one processor communicatively coupled to the memory and the at least one transceiver, the at least one processor configured to communicate traffic of a first type with a second UE via a first unicast link, setup, with the second UE, a second unicast link associated with traffic of a second type, associate the first and second unicast links together with a shared link management status, communicate the traffic of the second type with the second UE via the second unicast link, and maintain the shared link management status of the first and second unicast links based on the communicated traffic on any of the first and second unicast links.

Another aspect is directed to a base station, comprising a memory, at least one transceiver, and at least one processor communicatively coupled to the memory and the at least one transceiver, the at least one processor configured to receive, from a first user equipment (UE) that has already setup a first unicast link with a second UE for communication of traffic of a first type, a request for resources in association with link establishment of a second unicast link with the second UE for communication of traffic of a second type, determine that the first and second unicast links are to be associated with a shared link management status, determine a set of resources to support the second unicast link between the first UE and the second UE based at least in part upon the shared link management status determined for the first and second unicast links, and send, to the first UE, an indication of the set of resources.

Another aspect is directed to a first user equipment (UE), comprising means for communicating traffic of a first type with a second UE via a unicast link, means for setting up support for transport of traffic of a second type over the unicast link, and means for tunneling the traffic of the second type between the first UE and the second UE over the unicast link.

Another aspect is directed to a first user equipment (UE), comprising means for communicating traffic of a first type with a second UE via a first unicast link, means for setting up, with the second UE, a second unicast link associated with traffic of a second type, means for associating the first and second unicast links together with a shared link management status, means for communicating the traffic of the second type with the second UE via the second unicast link, and means for maintaining the shared link management status of the first and second unicast links based on the communicated traffic on any of the first and second unicast links.

Another aspect is directed to a base station, comprising means for receiving, from a first user equipment (UE) that has already setup a first unicast link with a second UE for communication of traffic of a first type, a request for resources in association with link establishment of a second unicast link with the second UE for communication of traffic of a second type, means for determining that the first and second unicast links are to be associated with a shared link management status, means for determining a set of resources to support the second unicast link between the first UE and the second UE based at least in part upon the shared link management status determined for the first and second unicast links, and means for sending, to the first UE, an indication of the set of resources.

Another aspect is directed to a non-transitory computer-readable medium storing computer-executable instructions, the computer-executable instructions comprising at least one instruction instructing a first user equipment (UE) to communicate traffic of a first type with a second UE via a unicast link, at least one instruction instructing the first UE to setup support for transport of traffic of a second type over the unicast link, and at least one instruction instructing the first UE to tunnel the traffic of the second type between the first UE and the second UE over the unicast link.

Another aspect is directed to a non-transitory computer-readable medium storing computer-executable instructions, the computer-executable instructions comprising at least one instruction instructing a first user equipment (UE) to communicate traffic of a first type with a second UE via a first unicast link, at least one instruction instructing the first UE to setup, with the second UE, a second unicast link associated with traffic of a second type, at least one instruction instructing the first UE to associate the first and second unicast links together with a shared link management status, at least one instruction instructing the first UE to communicate the traffic of the second type with the second UE via the second unicast link, and at least one instruction instructing the first UE to maintain the shared link management status of the first and second unicast links based on the communicated traffic on any of the first and second unicast links.

Another aspect is directed to a non-transitory computer-readable medium storing computer-executable instructions, the computer-executable instructions comprising at least one instruction instructing a base station to receive, from a first user equipment (UE) that has already setup a first unicast link with a second UE for communication of traffic of a first type, a request for resources in association with link establishment of a second unicast link with the second UE for communication of traffic of a second type, at least one instruction instructing the base station to determine that the first and second unicast links are to be associated with a shared link management status, at least one instruction instructing the base station to determine a set of resources to support the second unicast link between the first UE and the second UE based at least in part upon the shared link management status determined for the first and second unicast links, and at least one instruction instructing the base station to send, to the first UE, an indication of the set of resources.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of examples of one or more aspects of the disclosed subject matter and are provided solely for illustration of the examples and not limitation thereof:

FIG. 1 illustrates an exemplary wireless communications system in accordance with one or more aspects of the disclosure.

FIGS. 2A and 2B illustrate example wireless network structures, according to various aspects.

FIG. 3 illustrates an example of a wireless communications system that supports unicast sidelink establishment in accordance with aspects of the disclosure.

FIGS. 3A to 3C are simplified block diagrams of several sample aspects of components that may be employed in wireless communication nodes and configured to support communication as taught herein.

FIGS. 4A, 4B, and 4C illustrate several sample components that may be incorporated into a UE, a base station, and a network entity to support the file transmission operations as taught herein.

FIGS. 5 and 6 illustrate exemplary flows between an initiator device and a target device, according to aspects of the disclosure.

FIGS. 7 and 8 illustrate exemplary flows for establishing a non-standalone device-to-device communication session, according to aspects of the disclosure.

FIG. 9 illustrates an example initiator device for implementing the flow of FIG. 6 represented as a series of interrelated functional modules in accordance with an aspect of the disclosure.

FIG. 10 illustrates an example target device for implementing the flow of FIG. 7 represented as a series of interrelated functional modules in accordance with an aspect of the disclosure.

FIG. 11 illustrates an example UE for implementing the flow of FIG. 6 represented as a series of interrelated functional modules in accordance with an aspect of the disclosure.

FIG. 12 illustrates an example UE for implementing the flow of FIG. 8 represented as a series of interrelated functional modules in accordance with an aspect of the disclosure.

FIG. 13 illustrates an example BS for implementing the flow of FIG. 10 represented as a series of interrelated functional modules in accordance with an aspect of the disclosure.

### DETAILED DESCRIPTION

Disclosed are techniques for user equipment (UE)-to-UE (or device-to-device) communication of disparate traffic types over one or more unicast links (sometimes referred to as ‘unicast sidelinks’). In one aspect, a unicast link is associated with a first traffic type (e.g., IP traffic or non-IP traffic), and respective UEs coordinate so as to tunnel a second traffic type (e.g., non-IP traffic or IP traffic) over that same unicast link. In another aspect, a separate unicast link may be setup for transport of the second traffic type (i.e., without tunneling). In this aspect, the respective unicast links can be associated (e.g., bound together) so as to have a shared link management status. In a further aspect, if a base station determines that two unicast links are to be bound in this manner, the base station can allocate resource(s) based on this determination.

These and other aspects of the subject matter are provided in the following description and related drawings directed to specific examples of the disclosed subject matter. Alternates may be devised without departing from the scope of the disclosed subject matter. Additionally, well-known elements will not be described in detail or will be omitted so as not to obscure the relevant details.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein describes particular aspects only and should not be construed to limit any aspects disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “UE,” “vehicle UE” (V-UE), and “base station” are not intended to be specific or otherwise limited to any particular radio access technology (RAT), unless otherwise noted. In general, such UEs may be any wireless communication device (e.g., a vehicle onboard computer, a vehicle navigation device, a mobile phone, a router, a tablet computer, a laptop computer, a tracking device, an Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. A V-UE may be any in-vehicle wireless communication device, such as a navigation system, a warning system, a heads-up display (HUD), etc. Alternatively, a V-UE may be a portable wireless communication device (e.g., a cell phone, tablet computer, etc.) that belongs to the driver of the vehicle or a passenger in the vehicle. The term “V-UE” may refer to the in-vehicle wireless communication device or the vehicle itself, depending on the context. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a general Node B (gNodeB, gNB), etc. In addition, in some systems a base station may provide purely edge node signaling functions while in other systems it may provide additional control and/or network management functions.

UEs can be embodied by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

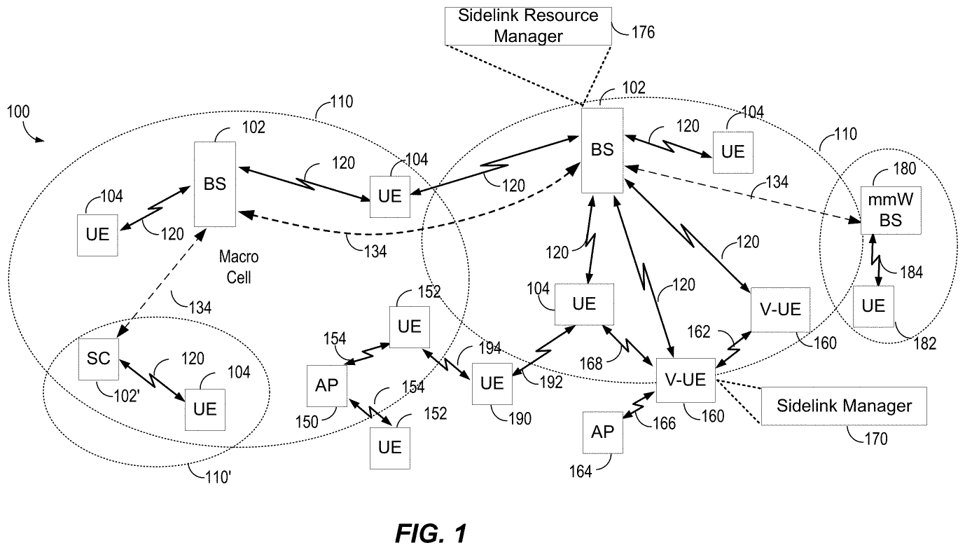

FIG. 1 illustrates an exemplary wireless communications system 100 according to one or more aspects. The wireless communications system 100, which may also be referred to as a wireless wide area network (WWAN), may include various base stations 102 and various UEs 104. The base stations 102 may include macro cells (high power cellular base stations) and/or small cells (low power cellular base stations). The macro cells may include Evolved NodeBs (eNBs) where the wireless communications system 100 corresponds to an LTE network, gNodeBs (gNBs) where the wireless communications system 100 corresponds to a 5G network, and/or a combination thereof, and the small cells may include femtocells, picocells, microcells, etc.

The base stations 102 may collectively form a RAN and interface with an evolved packet core (EPC) or next generation core (NGC) through backhaul links. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, although not shown in FIG. 1, coverage areas 110 may be subdivided into a plurality of cells (e.g., three), or sectors, each cell corresponding to a single antenna or array of antennas of a base station 102.

The term “cell” refers to a logical communication entity used for communication with a base station 102 (e.g., over a carrier frequency), and may be associated with an identifier for distinguishing neighboring cells (e.g., a physical cell identifier (PCID), an enhanced cell identifier (E-CID), a virtual cell identifier (VCID), etc.) operating via the same or a different carrier frequency. In some examples, a carrier frequency may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates. As used herein, the term “cell” or “sector” may correspond to one of a plurality of cells of a base station 102, or to the base station 102 itself, depending on the context.

While neighboring macro cell geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cells may be known as a heterogeneous network. A heterogeneous network may also include Home eNBs (HeNBs) and/or Home gNodeBs, which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 gigahertz (GHz)). When communicating in an unlicensed frequency spectrum, the WLAN STAs 152 and/or the WLAN AP 150 may perform a clear channel assessment (CCA) prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a mmW base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 may utilize beamforming 184 with the UE 182 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192-194 may be supported with any well-known D2D RAT, such as LTE Direct (LTE-D), WiFi Direct (WiFi-D), Bluetooth, and so on.

Leveraging the increased data rates and decreased latency of 5G, among other things, Vehicle-to-Everything (V2X) communication technologies are being implemented to support Intelligent Transportation Systems (ITS) applications, such as wireless communications between vehicles (Vehicle-to-Vehicle (V2V)), between vehicles and the roadside infrastructure (Vehicle-to-Infrastructure (V2I)), and between vehicles and pedestrians (Vehicle-to-Pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 (e.g., using the Uu interface). V-UEs 160 may also communicate directly with each other over a wireless unicast sidelink 162, with a roadside access point 164 over a sidelink 166, or with UEs 104 over a sidelink 168 using P2P/D2D protocols (e.g., “PCS,” an LTE V2X D2D interface) or ProSe direct communications. Sidelink communication may be used for D2D media-sharing, V2V communication, V2X communication (e.g., cellular V2X (cV2X) communication, enhanced V2X (eV2X) communication, etc.), emergency rescue applications, etc. One or more of a group of V-UEs 160 utilizing D2D communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via D2D communications may utilize a one-to-many (1:M) system in which each V-UE 160 transmits to every other V-UE 160 in the group. In some cases, a base station 102 facilitates the scheduling of resources for D2D communications. In other cases, D2D communications are carried out between V-UEs 160 without the involvement of a base station 102.

In an aspect, the V-UEs 160, and any other UE illustrated in FIG. 1, may have a sidelink manager 170. The sidelink manager 170 may be a hardware, software, or firmware component that, when executed, causes the V-UE 170 to perform the operations described herein. For example, the sidelink manager 170 may be a software module stored in a memory of the V-UE 160 and executable by a processor of the V-UE 160. As another example, the sidelink manager 170 may be a hardware circuit (e.g., an ASIC, a field programmable gate array (FPGA), etc.) within the V-UE 160.

In an aspect, the base station 102, and any other base station (or AP) illustrated in FIG. 1, may have a sidelink resource manager 176. The sidelink resource manager 176 may be a hardware, software, or firmware component that, when executed, causes the base station 102 to perform the operations described herein. For example, the sidelink resource manager 176 may be a software module stored in a memory of the base station 102 and executable by a processor of the base station 102. As another example, the sidelink resource manager 176 may be a hardware circuit (e.g., an ASIC, a field programmable gate array (FPGA), etc.) within the base station 102. As an example, the sidelink resource manager 176 may facilitate the base station 102 to select resource(s) for allocation to sidelink connections established between respective UEs.

In an aspect, the wireless sidelinks 162, 166, 168 may operate over a communication medium of interest, which may be shared with other communications between other vehicles and/or infrastructure access points, as well as other RATs. A “medium” may be composed of one or more frequency, time, and/or space communication resources (e.g., encompassing one or more channels across one or more carriers) associated with communication between one or more transmitter/receiver pairs.

In an aspect, the wireless sidelinks 162, 166, 168 may be cV2X links. A first generation of cV2X has been standardized in LTE, and the next generation is expected to be defined in 5G (also referred to as “New Radio” (NR) or “5G NR”). cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the wireless sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS GSA band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of code division multiple access (CDMA) systems, time division multiple access (TDMA) systems, frequency division multiple access (FDMA) systems, orthogonal FDMA (OFDMA) systems, single-carrier FDMA (SC-FDMA) systems, and so on.

Communications between the V-UEs 160 are referred to as V2V communications, communications between the V-UEs 160 and the one or more roadside access points 164 are referred to as V2I communications, and communications between the V-UEs 160 and one or more P-UEs 104 are referred to as V2P communications. The V2V communications between V-UEs 160 may include, for example, information about the position, speed, acceleration, heading, and other vehicle data of the V-UEs 160. The V2I information received at a V-UE 160 from the one or more roadside access points 164 may include, for example, road rules, parking automation information, etc. The V2P communications between a V-UE 160 and a P-UE 104 may include information about, for example, the position, speed, acceleration, and heading of the V-UE 160 and the position, speed (e.g., where the P-UE 104 is a bicycle), and heading of the P-UE 104.

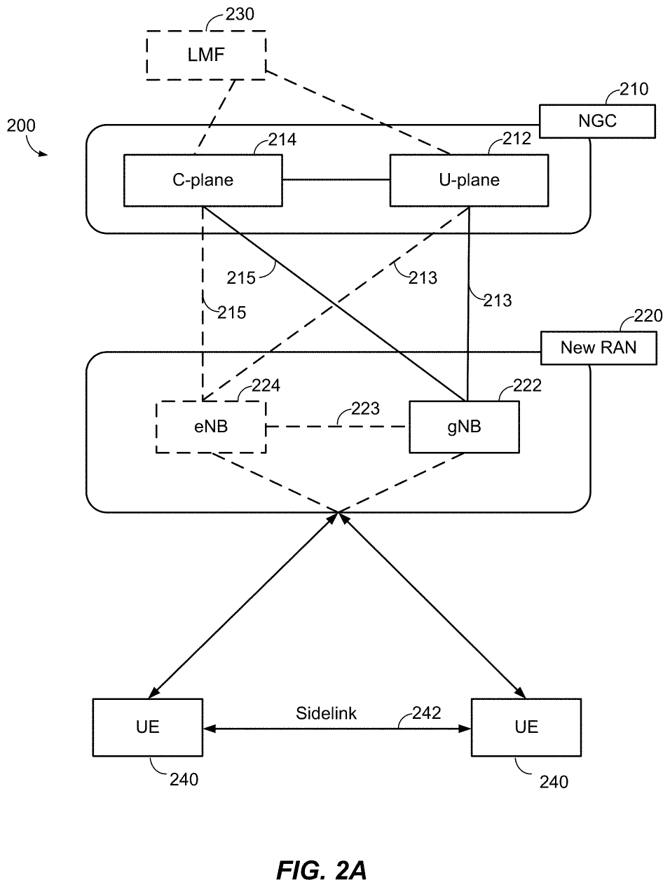

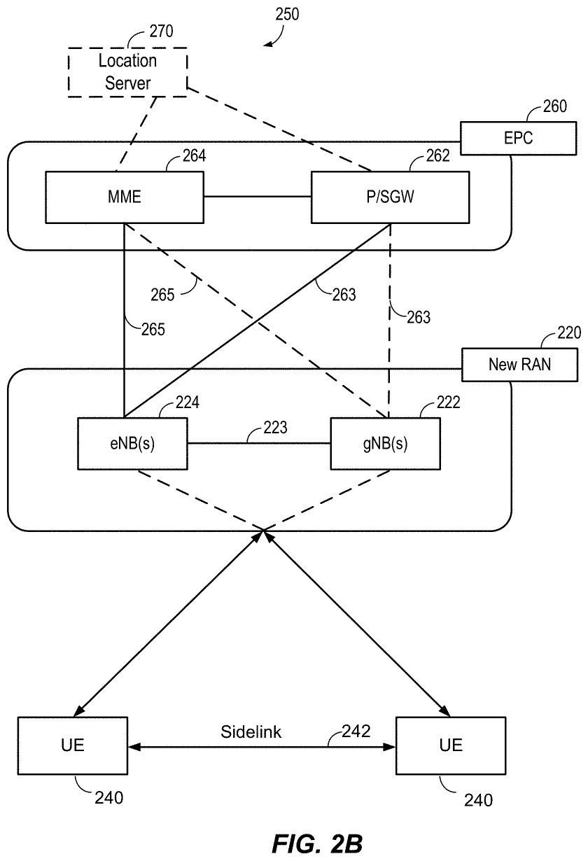

FIG. 2A illustrates an example wireless network structure 200 according to one or more aspects. For example, a Next Generation Core (NGC) 210 can be viewed functionally as control plane functions 214 (e.g., UE registration, authentication, network access, gateway selection, etc.) and user plane functions 212, (e.g., UE gateway function, access to data networks, IP routing, etc.) that operate cooperatively to form the core network. User plane interface (NG-U) 213 and control plane interface (NG-C) 215 connect one or more gNBs 222 to the NGC 210 and specifically to the control plane functions 214 and user plane functions 212. In an additional configuration, one or more eNBs 224 may also be connected to the NGC 210 via NG-C 215 to the control plane functions 214 and NG-U 213 to user plane functions 212. Further, eNB(s) 224 may directly communicate with gNB(s) 222 via a backhaul connection 223. Accordingly, in some configurations, the New RAN 220 may only have one or more gNBs 222, while other configurations include one or more of both eNBs 224 and gNBs 222. Either gNB(s) 222 or eNB(s) 224 may communicate with one or more UEs 240 (e.g., any of the UEs depicted in FIG. 1, such as UEs 104, UE 152, UE 160, UE 182, UE 190, etc.). In an aspect, two UEs 240 may communicate with each other over a wireless unicast sidelink 242, which may correspond to wireless unicast sidelink 162 in FIG. 1.

Another optional aspect may include a location management function (LMF) 230 in communication with the NGC 210 to provide location assistance for UEs 240. The LMF 230 determines, using information from the UE 240 and/or the New RAN 220, the current location of the UE 240 and provides it on request. The LMF 230 can be implemented as a plurality of structurally separate servers, or alternately may each correspond to a single server. Although FIG. 2A illustrates the LMF 230 as separate from the NGC 210 and the New RAN 220, it may instead be integrated into one or more components of the NGC 210 or the New RAN 220.

FIG. 2B illustrates an example wireless network structure 250 according to one or more aspects. For example, Evolved Packet Core (EPC) 260 can be viewed functionally as control plane functions, i.e., Mobility Management Entity (MME) 264, and user plane functions, i.e., Packet Data Network Gateway/Serving Gateway (P/SGW) 262, which operate cooperatively to form the core network. S1 control plane interface (S1-MME) 265 and S1 user plane interface (S1-U) 263 connect one or more eNBs 224 to the EPC 260, and specifically to MME 264 and P/SGW 262, respectively.

In an additional configuration, one or more gNBs 222 may also be connected to the EPC 260 via S1-MME 265 to MME 264 and S1-U 263 to P/SGW 262. Further, eNB(s) 224 may directly communicate with one or more gNBs 222 via the backhaul connection 223, with or without gNB direct connectivity to the EPC 260. Accordingly, in some configurations, the New RAN 220 may only have gNB(s) 222, while other configurations include both eNB(s) 224 and gNB(s) 222. Either gNB(s) 222 or eNB(s) 224 may communicate with one or more UEs 240 (e.g., any of the UEs depicted in FIG. 1, such as UEs 104, UE 182, UE 190, etc.). In an aspect, two UEs 240 may communicate with each other over a wireless unicast sidelink 242, which may correspond to wireless unicast sidelink 162 in FIG. 1.

Another optional aspect may include a location server 270 that may be in communication with the EPC 260 to provide location assistance for UE(s) 240. In an aspect, the location server 270 may be an Evolved Serving Mobile Location Center (E-SMLC), a Secure User Plane Location (SUPL) Location Platform (SLP), a Gateway Mobile Location Center (GMLC), or the like. The location server 270 can be implemented as a plurality of structurally separate servers, or alternately may each correspond to a single server. The location server 270 can be configured to support one or more location services for UE(s) 240 that can connect to the location server 270 via the core network, EPC 260, and/or via the Internet (not illustrated).

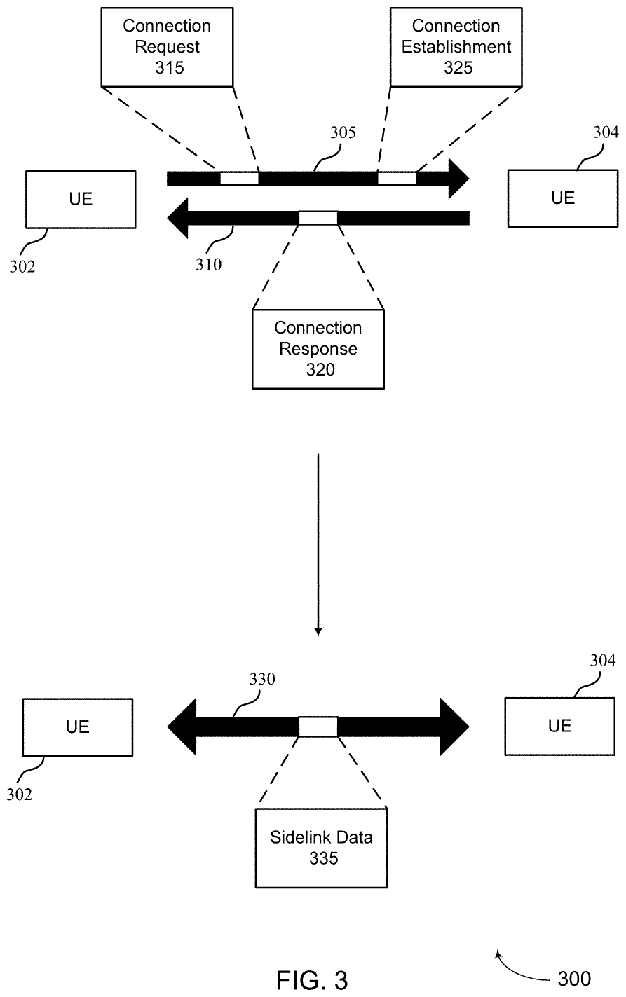

FIG. 3 illustrates an example of a wireless communications system 300 that supports unicast sidelink establishment in accordance with aspects of the disclosure. In some examples, wireless communications system 300 may implement aspects of wireless communications systems 100, 200, and 250. Wireless communications system 300 may include a first UE 302 and a second UE 304, which may be examples of any of the UEs depicted in FIG. 1, such as UEs 104, UE 152, UEs 160, UE 182, UE 190, etc., or the UEs 240 depicted in FIGS. 2A and 2B. A UE 302 may attempt to establish a unicast connection over a sidelink with UE 304, which may be a V2X communication link between UE 302 and UE 304. Additionally or alternatively, the unicast connection over the sidelink may generally be used for sidelink communications between any two UEs. Thus, the established sidelink connection may correspond to wireless sidelinks 162, 166, and/or 168 in FIG. 1 and/or wireless sidelink 242 in FIGS. 2A and 2B. In some cases, UE 302 may be referred to as an initiating UE that initiates the unicast connection procedure, and UE 304 may be referred to as a target UE that is targeted for the unicast connection procedure by the initiating UE.

For establishing the unicast connection, access stratum (AS) (a functional layer in the UMTS and LTE protocol stacks between the RAN and the UE that is responsible for transporting data over wireless links and managing radio resources, also referred to as “Layer 2”) parameters may be configured and negotiated between UE 302 and UE 304. For example, a transmission and reception capability matching may be negotiated between UE 302 and UE 304. Each UE may have different capabilities (e.g., transmission and reception capabilities, 64QAM, transmission diversity, carrier aggregation (CA) capabilities, supported communications frequency band(s), etc.). In some cases, different services may be supported at the upper layers of corresponding protocol stacks for UE 302 and UE 304. Additionally, a security association may be established between UE 302 and UE 304 for the unicast connection. Unicast traffic may benefit from security protection at a link level (e.g., Integrity Protection). Security requirements may differ for different wireless communications systems. For example, V2X and Uu systems may have different security requirements (e.g., Uu security does not include confidentiality protection). Additionally, Internet protocol (IP) configurations (e.g., IP versions, addresses, etc.) may be negotiated for the unicast connection between UE 302 and UE 304.

In some cases, UE 304 may create a service announcement (e.g., a service capability message) to transmit over a cellular network (e.g., cV2X) to assist the unicast connection establishment. Conventionally, UE 302 may identify and locate candidates for unicast communications based on a basic service message (BSM) broadcasted unencrypted by nearby UEs (e.g., UE 304). The BSM may include location information, security and identity information, and vehicle information (e.g., speed, maneuver, size, etc.) for the corresponding UE. However, for different wireless communications systems (e.g., D2D or V2X communications), a discovery channel may not be configured so that UE 302 is able to detect the BSM(s). Accordingly, the service announcement transmitted by UE 304 and other nearby UEs (e.g., a discovery signal) may be an upper layer signal and broadcasted (e.g., in a NR sidelink broadcast). In some cases, UE 304 may include one or more parameters for itself in the service announcement, including connection parameters and/or capabilities it possesses. UE 302 may then monitor for and receive the broadcasted service announcement to identify potential UEs for corresponding unicast connections. In some cases, UE 302 may identify the potential UEs based on the capabilities each UE indicates in their respective service announcements.

The service announcement may include information to assist UE 302 (e.g., or any initiating UE) to identify the UE transmitting the service announcement. For example, the service announcement may include channel information where direct communication requests may be sent. In some cases, the channel information may be specific to RAT (e.g., LTE or NR) and may include a resource pool that UE 302 transmits the communication request in. Additionally, the service announcement may include a specific destination address for the UE (e.g., a Layer 2 (L2) destination address) if the destination address is different from the current address (e.g., the address of the streaming provider or UE transmitting the service announcement). The service announcement may also include a network or transport layer for UE 302 to transmit a communication request on. For example, the network layer (also referred to as “Layer 3” or “L3”) or the transport layer (also referred to as “Layer 4” or “L4”) may indicate a port number of an application for the UE transmitting the service announcement. In some cases, no IP addressing may be needed if the signaling (e.g., PC5 signaling) carries a protocol (e.g., a real-time transport protocol (RTP)) directly or gives a locally-generated random protocol. Additionally, the service announcement may include a type of protocol for credential establishment and QoS-related parameters.

After identifying a potential unicast connection target (e.g., UE 304), UE 302 (e.g., the initiating UE) may transmit a connection request 315 to the identified target. In some cases, the connection request 315 may be a first RRC message transmitted by UE 302 to request a unicast connection with UE 304 (e.g., an RRCDirectConnectionSetupRequest message). For example, the unicast connection may utilize the PC5 interface for the unicast link, and the connection request 315 may be an RRC connection setup request message. Additionally, UE 302 may use a sidelink signaling radio bearer 305 to transport the connection request 315.

After receiving the connection request 315, UE 304 may determine whether to accept or reject the connection request 315. UE 304 may base this determination on a transmission/reception capability, an ability to accommodate the unicast connection over the sidelink, a particular service indicated for the unicast connection, the contents to be transmitted over the unicast connection, or a combination thereof. For example, if UE 302 wants to use a first RAT to transmit or receive data, but UE 304 does not support the first RAT, then UE 304 may reject the connection request 315. Additionally or alternatively, UE 304 may reject the connection request 315 based on being unable to accommodate the unicast connection over the sidelink due to a limited radio resource, a scheduling issue, etc. Accordingly, UE 304 may transmit an indication of whether the request is accepted or rejected in a connection response 320. Similar to UE 302 and the connection request 315, UE 304 may use a sidelink signaling radio bearer 310 to transport the connection response 320. Additionally, the connection response 320 may be a second RRC message transmitted by UE 304 in response to the connection request 315 (e.g., an RRCDirectConnectionResponse message).

In some cases, sidelink signaling radio bearers 305 and 310 may be a same sidelink radio signal bearer or may be separate sidelink signaling radio bearers. Accordingly, a radio link control (RLC) layer acknowledged mode (AM) may be used for sidelink signaling radio bearers 305 and 310. A UE that supports the unicast connection may listen on a logical channel associated with the sidelink signaling radio bearers. In some cases, the AS layer (i.e., Layer 2) may pass information directly through RRC signaling (e.g., control plane) instead of a V2X layer (e.g., data plane).

If the connection response 320 indicates that UE 304 accepted the connection request 315, UE 302 may then transmit a connection establishment 325 message on the sidelink signaling radio bearer 305 to indicate that the unicast connection setup is complete. In some cases, the connection establishment 325 may be a third RRC message (e.g., an RRCDirectConnectionSetupComplete message). Each of the connection request 315, the connection response 320, and the connection establishment 325 may use a basic capability when being transported from a UE to the other UE to enable each UE to be able to receive and decode a corresponding transmission (e.g., RRC message).

Additionally, identifiers may be used for each of the connection request 315, the connection response 320, and the connection establishment 325 (e.g., the RRC signaling). For example, the identifiers may indicate which UE 302/304 is transmitting which message and/or which UE 302/304 the message is intended for. For physical (PHY) channels, the RRC signaling and any subsequent data transmissions may use a same identifier (e.g., L2 IDs). However, for logical channels, the identifiers may be separate for the RRC signaling and for the data transmissions. For example, on the logical channels, the RRC signaling and the data transmissions may be treated differently and have different acknowledgement (ACK) feedback messaging. In some cases, for the RRC messaging, a PHY layer ACK may be used for ensuring the corresponding messages are transmitted and received properly.

One or more information elements may be included in the connection request 315 and/or the connection response 320 for UE 302 and/or UE 304, respectively, to enable negotiation of corresponding AS layer parameters for the unicast connection. For example, UE 302 and/or UE 304 may include packet data convergence protocol (PDCP) parameters in a corresponding unicast connection setup message to set a PDCP context for the unicast connection. In some cases, the PDCP context may indicate whether or not PDCP duplication is utilized for the unicast connection. Additionally, UE 302 and/or UE 304 may include RLC parameters when establishing the unicast connection to set an RLC context of the unicast connection. For example, the RLC context may indicate whether an AM (e.g., a reordering timer (t-reordering) is used) or an unacknowledged mode (UM) is used for the RLC layer of the unicast communications.

Additionally, UE 302 and/or UE 304 may include medium access control (MAC) parameters to set a MAC context for the unicast connection. In some cases, the MAC context may enable resource selection algorithms, a hybrid automatic repeat request (HARQ) feedback scheme (e.g., ACK or negative ACK (NACK) feedback), parameters for the HARQ feedback scheme, CA, or a combination thereof for the unicast connection. Additionally, UE 302 and/or UE 304 may include PHY layer parameters when establishing the unicast connection to set a PHY layer context for the unicast connection. For example, the PHY layer context may indicate a transmission format (unless transmission profiles are included for each UE) and a radio resource configuration (e.g., bandwidth part (BWP), numerology, etc.) for the unicast connection. These information elements may be supported for different frequency range configurations (e.g., frequency range 1 (FR1) for a sub-6 GHz frequency band, typically 450 MHz to 6000 MHz, and frequency range 2 (FR2) for mmW, typically 24250 MHz to 52600 MHz).

In some cases, a security context may also be set for the unicast connection (e.g., after the connection establishment 325 message is transmitted). Before a security association (e.g., security context) is established between UE 302 and UE 304, the sidelink signaling radio bearers 305 and 310 may not be protected. After a security association is established, the sidelink signaling radio bearers 305 and 310 may be protected. Accordingly, the security context may enable secure data transmissions over the unicast connection and the sidelink signaling radio bearers 305 and 310. Additionally, IP layer parameters (e.g., link-local IPv4 or IPv6 addresses) may also be negotiated. In some cases, the IP layer parameters may be negotiated by an upper layer control protocol running after RRC signaling is established (e.g., the unicast connection is established. As noted above, UE 304 may base its decision on whether to accept or reject the connection request 315 on a particular service indicated for the unicast connection and/or the contents to be transmitted over the unicast connection (e.g., upper layer information). The particular service and/or contents may be also indicated by an upper layer control protocol running after RRC signaling is established.

After the unicast connection is established, UE 302 and UE 304 may communicate using the unicast connection over a sidelink 330, where sidelink data 335 is transmitted between the two UEs 302 and 304. In some cases, the sidelink data 335 may include RRC messages transmitted between the two UEs 302 and 304. To maintain this unicast connection on sidelink 330, UE 302 and/or UE 304 may transmit a keep alive message (e.g., RRCDirectLinkAlive message, a fourth RRC message, etc.). In some cases, the keep alive message may be triggered periodically or on-demand (e.g., event-triggered). Accordingly, the triggering and transmission of the keep alive message may be invoked by UE 302 or by both UE 302 and UE 304. Additionally or alternatively, a MAC control element (CE) (e.g., defined over sidelink 330) may be used to monitor the status of the unicast connection on sidelink 330 and maintain the connection. When the unicast connection is no longer needed (e.g., UE 302 travels far enough away from UE 304), either UE 302 and/or UE 304 may start a release procedure to drop the unicast connection over sidelink 330. Accordingly, subsequent RRC messages may not be transmitted between UE 302 and UE 304 on the unicast connection.

FIGS. 3A, 3B, and 3C illustrate several sample components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include wireless wide area network (WWAN) transceiver 310 and 350, respectively, configured to communicate via one or more wireless communication networks (not shown), such as an NR network, an LTE network, a GSM network, and/or the like. The WWAN transceivers 310 and 350 may be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 also include, at least in some cases, wireless local area network (WLAN) transceivers 320 and 360, respectively. The WLAN transceivers 320 and 360 may be connected to one or more antennas 326 and 366, respectively, for communicating with other network nodes, such as other UEs, access points, base stations, etc., via at least one designated RAT (e.g., WiFi, LTE-D, Bluetooth®, etc.) over a wireless communication medium of interest. The WLAN transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively.

Transceiver circuitry including a transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 316, 336, and 376), such as an antenna array, that permits the respective apparatus to perform transmit “beamforming,” as described herein. Similarly, a receiver may include or be coupled to a plurality of antennas (e.g., antennas 316, 336, and 376), such as an antenna array, that permits the respective apparatus to perform receive beamforming, as described herein. In an aspect, the transmitter and receiver may share the same plurality of antennas (e.g., antennas 316, 336, and 376), such that the respective apparatus can only receive or transmit at a given time, not both at the same time. A wireless communication device (e.g., one or both of the transceivers 310 and 320 and/or 350 and 360) of the apparatuses 302 and/or 304 may also comprise a network listen module (NLM) or the like for performing various measurements.

The apparatuses 302 and 304 also include, at least in some cases, satellite positioning systems (SPS) receivers 330 and 370. The SPS receivers 330 and 370 may be connected to one or more antennas 336 and 376, respectively, for receiving SPS signals 338 and 378, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 330 and 370 may comprise any suitable hardware and/or software for receiving and processing SPS signals 338 and 378, respectively. The SPS receivers 330 and 370 request information and operations as appropriate from the other systems, and performs calculations necessary to determine the apparatus' 302 and 304 positions using measurements obtained by any suitable SPS algorithm.

The base station 304 and the network entity 306 each include at least one network interfaces 380 and 390 for communicating with other network entities. For example, the network interfaces 380 and 390 (e.g., one or more network access ports) may be configured to communicate with one or more network entities via a wire-based or wireless backhaul connection. In some aspects, the network interfaces 380 and 390 may be implemented as transceivers configured to support wire-based or wireless signal communication. This communication may involve, for example, sending and receiving: messages, parameters, or other types of information.

The apparatuses 302, 304, and 306 also include other components that may be used in conjunction with the operations as disclosed herein. The UE 302 includes processor circuitry implementing a processing system 332 for providing functionality relating to, for example, false base station (FBS) detection as disclosed herein and for providing other processing functionality. The base station 304 includes a processing system 384 for providing functionality relating to, for example, FBS detection as disclosed herein and for providing other processing functionality. The network entity 306 includes a processing system 394 for providing functionality relating to, for example, FBS detection as disclosed herein and for providing other processing functionality. In an aspect, the processing systems 332, 384, and 394 may include, for example, one or more general purpose processors, multi-core processors, ASICs, digital signal processors (DSPs), field programmable gate arrays (FPGA), or other programmable logic devices or processing circuitry.

The apparatuses 302, 304, and 306 include memory circuitry implementing memory components 340, 386, and 396 (e.g., each including a memory device), respectively, for maintaining information (e.g., information indicative of reserved resources, thresholds, parameters, and so on). In some cases, the apparatuses 302, 304, and 306 may include DCI-triggered PRS modules 342, 388, and 398, respectively. The DCI-triggered PRS modules 342, 388, and 398 may be hardware circuits that are part of or coupled to the processing systems 332, 384, and 394, respectively, that, when executed, cause the apparatuses 302, 304, and 306 to perform the functionality described herein. Alternatively, the DCI-triggered PRS modules 342, 388, and 398 may be memory modules (as shown in FIGS. 3A-C) stored in the memory components 340, 386, and 396, respectively, that, when executed by the processing systems 332, 384, and 394, cause the apparatuses 302, 304, and 306 to perform the functionality described herein.

The UE 302 may include one or more sensors 344 coupled to the processing system 332 to provide movement and/or orientation information that is independent of motion data derived from signals received by the WWAN transceiver 310, the WLAN transceiver 320, and/or the GPS receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in 2D and/or 3D coordinate systems.

In addition, the UE 302 includes a user interface 346 for providing indications (e.g., audible and/or visual indications) to a user and/or for receiving user input (e.g., upon user actuation of a sensing device such a keypad, a touch screen, a microphone, and so on). Although not shown, the apparatuses 304 and 306 may also include user interfaces.

Referring to the processing system 384 in more detail, in the downlink, IP packets from the network entity 306 may be provided to the processing system 384. The processing system 384 may implement functionality for an RRC layer, a packet data convergence protocol (PDCP) layer, a radio link control (RLC) layer, and a medium access control (MAC) layer. The processing system 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the processing system 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the processing system 332, which implements Layer-3 and Layer-2 functionality.

In the UL, the processing system 332 provides demultiplexing between transport and logical channels, packet reassembly, deciphering, header decompression, and control signal processing to recover IP packets from the core network. The processing system 332 is also responsible for error detection.

Similar to the functionality described in connection with the DL transmission by the base station 304, the processing system 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The UL transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the processing system 384.

In the UL, the processing system 384 provides demultiplexing between transport and logical channels, packet reassembly, deciphering, header decompression, control signal processing to recover IP packets from the UE 302. IP packets from the processing system 384 may be provided to the core network. The processing system 384 is also responsible for error detection.

For convenience, the apparatuses 302, 304, and/or 306 are shown in FIGS. 3A-C as including various components that may be configured according to the various examples described herein. It will be appreciated, however, that the illustrated blocks may have different functionality in different designs.

The various components of the apparatuses 302, 304, and 306 may communicate with each other over data buses 334, 382, and 392, respectively. The components of FIGS. 3A-C may be implemented in various ways. In some implementations, the components of FIGS. 3A-C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a positioning entity,” etc. However, as will be appreciated, such operations, acts, and/or functions may actually be performed by specific components or combinations of components of the UE, base station, positioning entity, etc., such as the processing systems 332, 384, 394, the transceivers 310, 320, 350, and 360, the memory components 340, 386, and 396, the DCI-triggered PRS modules 342, 388, and 398, etc.

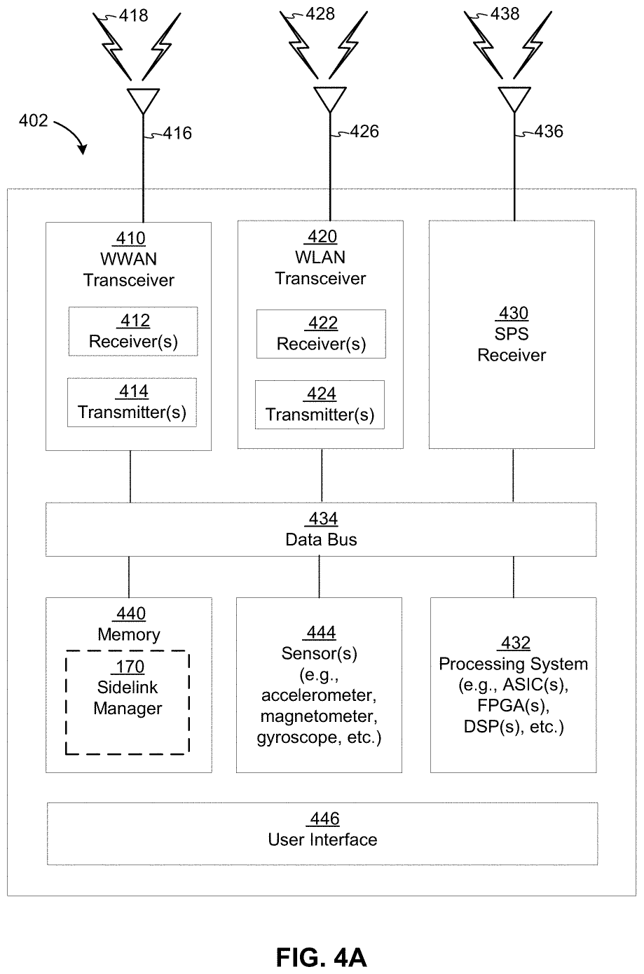

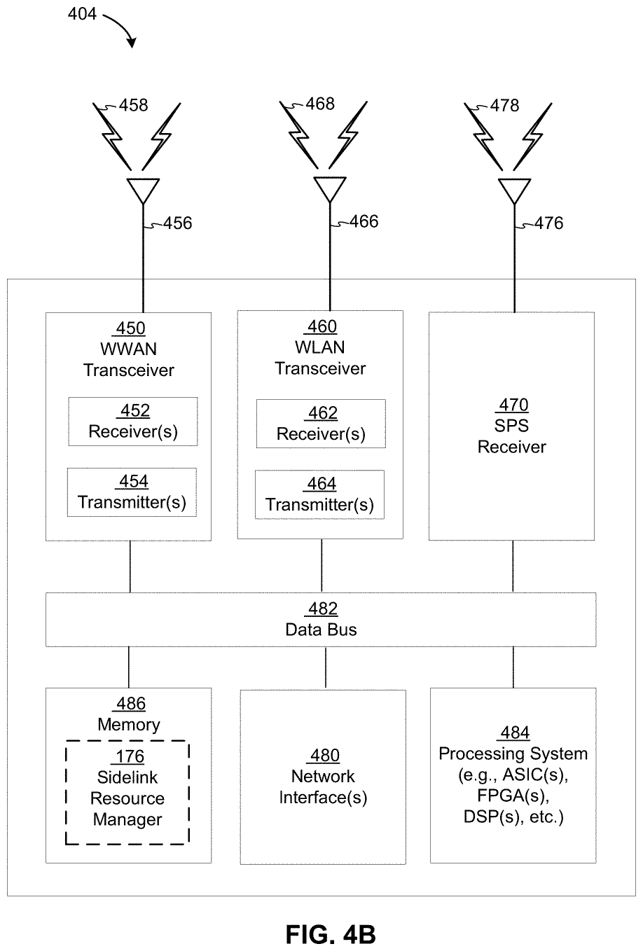

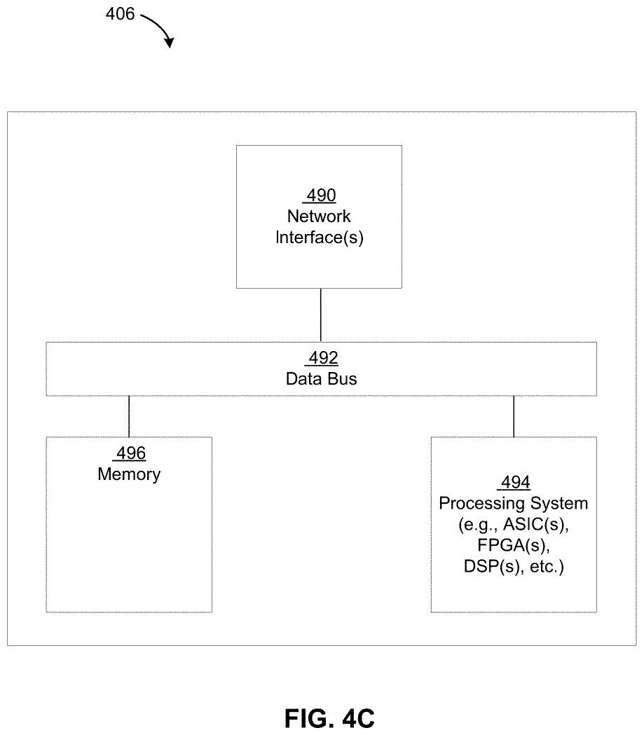

FIGS. 4A, 4B, and 4C illustrate several sample components (represented by corresponding blocks) that may be incorporated into a UE 402 (which may correspond to any of the UEs described herein), a base station 404 (which may correspond to any of the base stations described herein), and a network entity 406 (which may correspond to or embody any of the network functions described herein, including the location server 230 and the LMF 270) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 402 and the base station 404 each include wireless wide area network (WWAN) transceiver 410 and 450, respectively, configured to communicate via one or more wireless communication networks (not shown), such as an NR network, an LTE network, a GSM network, and/or the like. The WWAN transceivers 410 and 450 may be connected to one or more antennas 416 and 456, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 410 and 450 may be variously configured for transmitting and encoding signals 418 and 458 (e.g., messages, indications, information, and so on), respectively, and, conversely, for receiving and decoding signals 418 and 458 (e.g., messages, indications, information, pilots, and so on), respectively, in accordance with the designated RAT. Specifically, the transceivers 410 and 450 include one or more transmitters 414 and 454, respectively, for transmitting and encoding signals 418 and 458, respectively, and one or more receivers 412 and 452, respectively, for receiving and decoding signals 418 and 458, respectively.

The UE 402 and the base station 404 also include, at least in some cases, wireless local area network (WLAN) transceivers 420 and 460, respectively. The WLAN transceivers 420 and 460 may be connected to one or more antennas 426 and 466, respectively, for communicating with other network nodes, such as other UEs, access points, base stations, etc., via at least one designated RAT (e.g., WiFi, LTE-D, Bluetooth®, etc.) over a wireless communication medium of interest. The WLAN transceivers 420 and 460 may be variously configured for transmitting and encoding signals 428 and 468 (e.g., messages, indications, information, and so on), respectively, and, conversely, for receiving and decoding signals 428 and 468 (e.g., messages, indications, information, pilots, and so on), respectively, in accordance with the designated RAT. Specifically, the transceivers 420 and 460 include one or more transmitters 424 and 464, respectively, for transmitting and encoding signals 428 and 468, respectively, and one or more receivers 422 and 462, respectively, for receiving and decoding signals 428 and 468, respectively.

Transceiver circuitry including a transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 416, 436, and 476), such as an antenna array, that permits the respective apparatus to perform transmit “beamforming,” as described herein. Similarly, a receiver may include or be coupled to a plurality of antennas (e.g., antennas 416, 436, and 476), such as an antenna array, that permits the respective apparatus to perform receive beamforming, as described herein. In an aspect, the transmitter and receiver may share the same plurality of antennas (e.g., antennas 416, 436, and 476), such that the respective apparatus can only receive or transmit at a given time, not both at the same time. A wireless communication device (e.g., one or both of the transceivers 410 and 420 and/or 450 and 460) of the apparatuses 402 and/or 404 may also comprise a network listen module (NLM) or the like for performing various measurements.

The apparatuses 402 and 404 also include, at least in some cases, satellite positioning systems (SPS) receivers 430 and 470. The SPS receivers 430 and 470 may be connected to one or more antennas 436 and 476, respectively, for receiving SPS signals 438 and 478, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 430 and 470 may comprise any suitable hardware and/or software for receiving and processing SPS signals 438 and 478, respectively. The SPS receivers 430 and 470 request information and operations as appropriate from the other systems, and performs calculations necessary to determine the apparatus' 402 and 404 positions using measurements obtained by any suitable SPS algorithm.

The base station 404 and the network entity 406 each include at least one network interfaces 480 and 490 for communicating with other network entities. For example, the network interfaces 480 and 490 (e.g., one or more network access ports) may be configured to communicate with one or more network entities via a wire-based or wireless backhaul connection. In some aspects, the network interfaces 480 and 490 may be implemented as transceivers configured to support wire-based or wireless signal communication. This communication may involve, for example, sending and receiving: messages, parameters, or other types of information.

The apparatuses 402, 404, and 406 also include other components that may be used in conjunction with the operations as disclosed herein. The UE 402 includes processor circuitry implementing a processing system 432 for providing functionality relating to, for example, false base station (FBS) detection as disclosed herein and for providing other processing functionality. The base station 404 includes a processing system 484 for providing functionality relating to, for example, FBS detection as disclosed herein and for providing other processing functionality. The network entity 406 includes a processing system 494 for providing functionality relating to, for example, FBS detection as disclosed herein and for providing other processing functionality. In an aspect, the processing systems 432, 484, and 494 may include, for example, one or more general purpose processors, multi-core processors, ASICs, digital signal processors (DSPs), field programmable gate arrays (FPGA), or other programmable logic devices or processing circuitry.

The apparatuses 402, 404, and 406 include memory circuitry implementing memory components 440, 486, and 496 (e.g., each including a memory device), respectively, for maintaining information (e.g., information indicative of reserved resources, thresholds, parameters, and so on). In some cases, the apparatus 402 may include the sidelink manager 170, and the apparatus 404 may include the sidelink resource manager 176. The sidelink manager 170 and the sidelink resource manager 176 may be hardware circuits that are part of or coupled to the processing systems 432, 484, and 494, respectively, that, when executed, cause the apparatuses 402, 404, and 406 to perform the functionality described herein. Alternatively, the sidelink manager 170 and the sidelink resource manager 176 may be memory modules (as shown in FIGS. 4A-C) stored in the memory components 440, 486, and 496, respectively, that, when executed by the processing systems 432, 484, and 494, cause the apparatuses 402, 404, and 406 to perform the functionality described herein.

The UE 402 may include one or more sensors 444 coupled to the processing system 432 to provide movement and/or orientation information that is independent of motion data derived from signals received by the WWAN transceiver 410, the WLAN transceiver 420, and/or the GPS receiver 430. By way of example, the sensor(s) 444 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 444 may include a plurality of different types of devices and combine their outputs in order to provide motion information. For example, the sensor(s) 444 may use a combination of a multi-axis accelerometer and orientation sensors to provide the ability to compute positions in 2D and/or 4D coordinate systems.

In addition, the UE 402 includes a user interface 446 for providing indications (e.g., audible and/or visual indications) to a user and/or for receiving user input (e.g., upon user actuation of a sensing device such a keypad, a touch screen, a microphone, and so on). Although not shown, the apparatuses 404 and 406 may also include user interfaces.

Referring to the processing system 484 in more detail, in the downlink, IP packets from the network entity 406 may be provided to the processing system 484. The processing system 484 may implement functionality for an RRC layer, a packet data convergence protocol (PDCP) layer, a radio link control (RLC) layer, and a medium access control (MAC) layer. The processing system 484 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 454 and the receiver 452 may implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 454 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 402. Each spatial stream may then be provided to one or more different antennas 456. The transmitter 454 may modulate an RF carrier with a respective spatial stream for transmission.

At the UE 402, the receiver 412 receives a signal through its respective antenna(s) 416. The receiver 412 recovers information modulated onto an RF carrier and provides the information to the processing system 432. The transmitter 414 and the receiver 412 implement Layer-1 functionality associated with various signal processing functions. The receiver 412 may perform spatial processing on the information to recover any spatial streams destined for the UE 402. If multiple spatial streams are destined for the UE 402, they may be combined by the receiver 412 into a single OFDM symbol stream. The receiver 412 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 404. These soft decisions may be based on channel estimates computed by a channel estimator. The soft decisions are then decoded and de-interleaved to recover the data and control signals that were originally transmitted by the base station 404 on the physical channel. The data and control signals are then provided to the processing system 432, which implements Layer-3 and Layer-2 functionality.

In the UL, the processing system 432 provides demultiplexing between transport and logical channels, packet reassembly, deciphering, header decompression, and control signal processing to recover IP packets from the core network. The processing system 432 is also responsible for error detection.

Similar to the functionality described in connection with the DL transmission by the base station 404, the processing system 432 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

Channel estimates derived by the channel estimator from a reference signal or feedback transmitted by the base station 404 may be used by the transmitter 414 to select the appropriate coding and modulation schemes, and to facilitate spatial processing. The spatial streams generated by the transmitter 414 may be provided to different antenna(s) 416. The transmitter 414 may modulate an RF carrier with a respective spatial stream for transmission.

The UL transmission is processed at the base station 404 in a manner similar to that described in connection with the receiver function at the UE 402. The receiver 452 receives a signal through its respective antenna(s) 456. The receiver 452 recovers information modulated onto an RF carrier and provides the information to the processing system 484.

In the UL, the processing system 484 provides demultiplexing between transport and logical channels, packet reassembly, deciphering, header decompression, control signal processing to recover IP packets from the UE 402. IP packets from the processing system 484 may be provided to the core network. The processing system 484 is also responsible for error detection.

For convenience, the apparatuses 402, 404, and/or 406 are shown in FIGS. 4A-C as including various components that may be configured according to the various examples described herein. It will be appreciated, however, that the illustrated blocks may have different functionality in different designs.

The various components of the apparatuses 402, 404, and 406 may communicate with each other over data buses 434, 482, and 492, respectively. The components of FIGS. 4A-C may be implemented in various ways. In some implementations, the components of FIGS. 4A-C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 410 to 446 may be implemented by processor and memory component(s) of the UE 402 (e.g., by execution of appropriate code and/or by appropriate configuration of processor components). Similarly, some or all of the functionality represented by blocks 450 to 488 may be implemented by processor and memory component(s) of the base station 404 (e.g., by execution of appropriate code and/or by appropriate configuration of processor components). Also, some or all of the functionality represented by blocks 490 to 496 may be implemented by processor and memory component(s) of the network entity 406 (e.g., by execution of appropriate code and/or by appropriate configuration of processor components). For simplicity, various operations, acts, and/or functions are described herein as being performed “by a UE,” “by a base station,” “by a positioning entity,” etc. However, as will be appreciated, such operations, acts, and/or functions may actually be performed by specific components or combinations of components of the UE, base station, positioning entity, etc., such as the processing systems 432, 484, 494, the transceivers 410, 420, 450, and 460, the memory components 440, 486, and 496, the sidelink manager 170 and the sidelink resource manager 176, etc.

In NR systems, sidelink communications (e.g., UE-to-UE communications) may be associated with one of three modes; namely, unicast, groupcast (or multicast), or broadcast. In 3GPP Rel. 16 eV2X design, an L2 unicast link (e.g., PC5 unicast link) can support either IP traffic or non-IP traffic, but not both. Similar transport protocols (i.e., separation of IP traffic from non-IP traffic) may be defined in other designs as well, such as any unicast sidelink design that is based on V2X (e.g., 3GPP Rel. 17 ProSe/NR unicast sidelink, etc.). For example, if two UEs are using the same application-layer ID pair (e.g., using the same application), two separate L2 unicast links are setup in a scenario where some communicated traffic is IP traffic and other communicated traffic is non-IP traffic (e.g., a Wireless Access for Vehicular Environment (WAVE) (WAVE) Short Message Protocol (WSMP) message). In current standards, each L2 unicast link requires a separate RRC connection to be established, since each L2 unicast link is associated with its own respective L2 ID. Hence, two L2 unicast links between the same UEs and associated with the same application may require redundant signaling (e.g., PC5-S link keep-alive packets, link identifier updates, PC5-RRC signaling, etc.

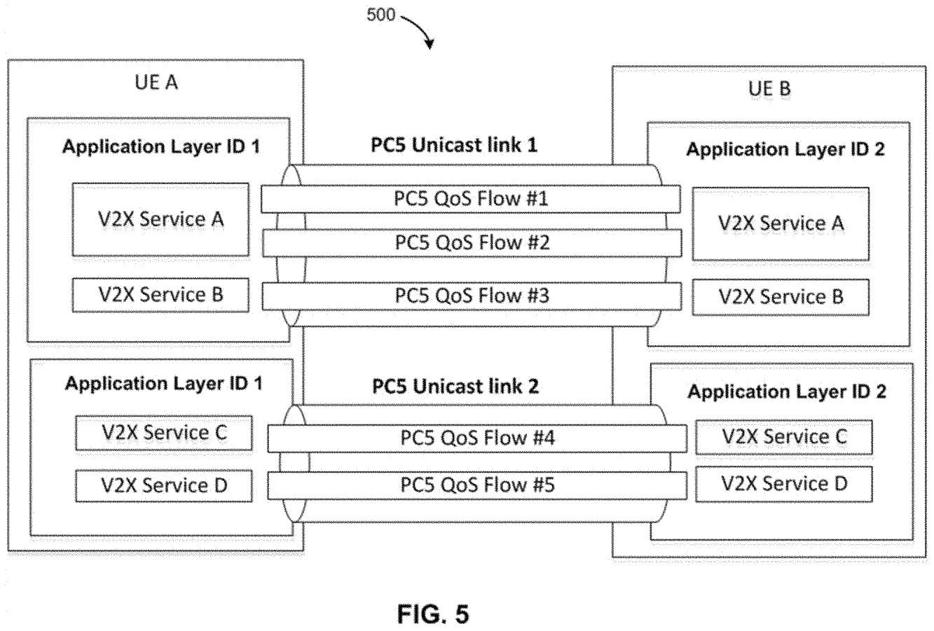

FIG. 5 illustrates V2X communication flows 500 between UE A and UE B in accordance with current unicast sidelink standards. As shown in FIG. 5, PC5 Unicast links 1-2 are established between UEs A and B. PC5 QoS Flows #1-#2 are established between UEs A and B on PC5 Unicast link 1 with respect to V2X Service A, PC5 QoS Flow #3 is established between UEs A and B on PC5 Unicast link 1 with respect to V2X Service B, PC5 QoS Flow #4 is established between UEs A and B on PC5 Unicast link 2 with respect to V2X Service C, and PC5 QoS Flow #5 is established between UEs A and B on PC5 Unicast link 2 with respect to V2X Service D.

Referring to FIG. 5, the Application Layer IDs associated with both PC5 Unicast links 1-2 are the same. Further assume that per requirements of current standards, V2X Services A-B are associated with a first type of traffic (e.g., IP traffic or non-IP traffic), whereas V2X Services C-D are associated with a second type of traffic (e.g., non-IP traffic or IP traffic). For example, some current standards require that a PC5 unicast link which supports V2X communication to use a single network layer protocol e.g., IP or non-IP. In this case, when the Application layer in the UE initiates data transfer for a V2X service type which requires unicast mode of communication over PC5 reference point the UE shall reuse an existing PC5 unicast link only if the pair of peer Application Layer IDs and the network layer protocol of this PC5 unicast link are identical to those required by the application layer in the UE for this V2X service, and modify the existing PC5 unicast link to add this V2X service type; otherwise, the UE shall trigger the establishment of a new PC5 unicast link. Under such standards, even though the Application Layer IDs are the same, the association of new PC5 QoS flows with a different network layer protocol (e.g., IP or non-IP) triggers the use of a separate PC5 Unicast link, as shown in FIG. 5.

Referring to FIG. 5, since the PC5 Unicast links 1-2 correspond to separate L2 IDs, PC5 Unicast links 1-2 are presented as two separate connections at AS layer per current standards. For example, current standards specify that a PC5-RRC connection is a logical connection between two UEs for a pair of Source and Destination Layer-2 IDs which is considered to be established after a corresponding PC5 unicast link is established. There is one-to-one correspondence between the PC5-RRC connection and the PC5 unicast link. A UE may have multiple PC5-RRC connections with one or more UEs for different pairs of Source and Destination Layer-2 IDs. Therefore, for the same Application Layer ID pairs, UE A and UE B still need to use two different unicast links if there are both IP and non-IP traffic, under current standards. This requires separate link management and maintenance, which wastes UE power and radio resources (e.g., in case keep alive signaling is required).

Embodiments of the disclosure are directed to configuring a single unicast link between UEs (e.g., a unicast sidelink) to transport disparate traffic types (e.g., non-IP traffic and IP traffic). Other embodiments of the disclosure are directed to deploying first and second unicast links between UEs (e.g., separate sitelinks) to transport first and second traffic types, respectively, while further implementing a shared link management status with respect to the first and second unicast links.

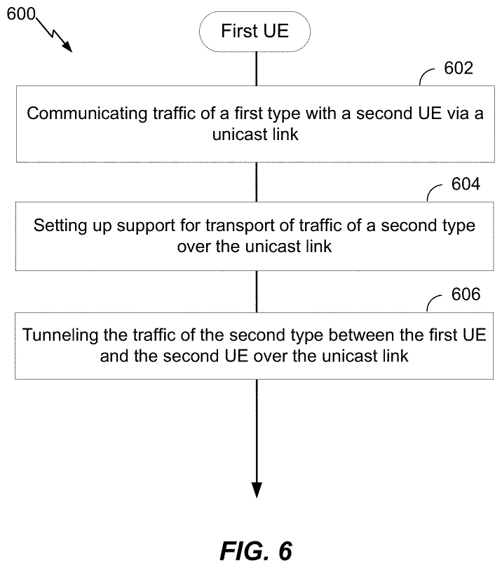

FIG. 6 illustrates a communication process 600 in accordance with an embodiment of the disclosure. The process 600 of FIG. 6 is performed by a first UE, such as UEs 104, 152, 160, 182, 190, any of UEs 240 depicted in FIGS. 2A and 2B, any of UEs 302, 304 in FIG. 3, UE 402 in FIG. 4A, UEs A or B in FIG. 5, etc.). For example, the process 600 may be performed via the sidelink manager 170 in some designs.

Referring to FIG. 6, at 602, the first UE communicates traffic of a first type with a second UE via a unicast link. The traffic of the first type may correspond to non-IP traffic or non-IP traffic. The unicast link in some designs may correspond to a D2D, Unicast sidelink, or V2X unicast link, such as PC5 unicast link. The traffic communicated at 602 may comprise traffic transmitted by the first UE to the second UE, traffic transmitted by the second UE to the first UE, or a combination thereof.

Referring to FIG. 6, at 604, the first UE sets up support for transport of traffic of a second type over the unicast link. In an example, 604 may involve coordination between the first UE and the second UE. In a further example, either the first UE or the second UE may initiate the coordination of 604.

Referring to FIG. 6, at 606, the first UE tunnels the traffic of the second type between the first UE and the second UE over the unicast link. The traffic tunneled at 606 may comprise traffic transmitted by the first UE to the second UE, traffic transmitted by the second UE to the first UE, or a combination thereof.

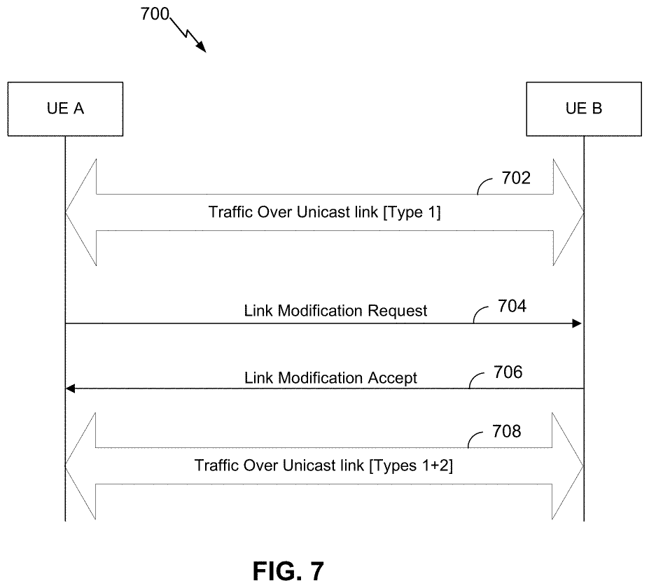

FIG. 7 illustrates an example implementation of the process 600 of FIG. 6 in accordance with an embodiment of the disclosure. The first UE described in context with FIG. 6 may correspond to either UE A or UE B in context with FIG. 7.

Referring to FIG. 7, at 702 (e.g., as in 602 of FIG. 6), UEs A and B communicate a first type of traffic over a unicast link. At 704, UE A transmits a link modification request message to UE B over the unicast link. In this case, the link modification request message requests that a new QoS flow be added to support a second type of traffic. At 706, UE B transmits a link modification accept message back to UE A. 704-706 of FIG. 7 represent an example implementation of 604 of FIG. 6 in one example. At 708 (e.g., as in 606 of FIG. 6), UEs A and B communicate both traffic types over the unicast link, with the second type of traffic being tunneled.

Referring to FIG. 6, in an example where the traffic of the first type corresponds to IP traffic and the traffic of the second type corresponds to non-IP traffic, 604 may comprise identifying a QoS flow identifier (e.g., PC5 QoS Flow ID) for transport of the non-IP traffic over the unicast link, and the tunneling at 606 may comprise encapsulating a first subset of the non-IP traffic for transmission from the first UE to the second UE over the unicast link in association with the identified QoS flow identifier, and un-encapsulating a second subset of the non-IP traffic received at the first UE from the second UE over the unicast link in association with the identified QoS flow identifier. In an example, the encapsulated non-IP traffic may be encapsulated within User Datagram Protocol (UDP), Transmission Control Protocol (TCP), or ‘raw’ IP. As an example, the QoS flow identifier(s) associated with the non-IP flow(s) may be identified in a QoS Information Element of the link modification request message from 704 of FIG. 7 in an example, whereby UE A provides an indication to UE B of the non-IP association and the corresponding encapsulation/un-encapsulation protocol (e.g., the indication may be an explicit indication in a PC5-S message, a new QoS Information indicator, or via a new PC5 QoS profile (PQI), etc.). In a further example, UE A may define PC5 QoS rule(s) for such encapsulated non-IP flow(s) to map to the corresponding PC5 QoS Flow IDs (e.g., such rules can be defined as an extension of the PC5 Packet Filter Set as defined in current standards, to facilitate a combined IP and non-IP PC5 Packet Filter). UE A can convey the PC5 QoS rule(s) to UE B (e.g., via the link modification request message of 704), and UE B can create corresponding handling rule(s) (e.g., encapsulation/un-encapsulation) for such traffic. In a specific example, the V2X Layer/ProSe Layer may strip off the IP/UDP or IP/TCP header(s) of the received packets and pass the embedded non-IP content (which is now un-encapsulated via the header stripping) to the non-IP stack. In a further example, 604 may further comprise identification of a port for transport of the non-IP traffic in the IP over the unicast link. In this case, the encapsulated first subset may be further transmitted over the unicast link with the identified port, and the un-encapsulated second subset may be received over the unicast link with the identified port.

Referring to FIG. 6, in an example where the traffic of the first type corresponds to non-IP traffic and the traffic of the second type corresponds to IP traffic, 604 may comprise identifying a identifying a non-IP header (e.g., defined in the standard for pre-association with IP traffic, or dynamically generated/negotiated) to be used for transport of the IP traffic over the unicast link, and identifying a QoS flow identifier (e.g., PC5 QoS Flow ID) for transport of the IP traffic over the unicast link, and the tunneling of 606 may comprise encapsulating a first subset of the IP traffic for transmission from the first UE to the second UE over the unicast link in association with the identified non-IP header and the identified QoS flow identifier, and un-encapsulating a second subset of the IP traffic received at the first UE from the second UE over the unicast link in association with the identified non-IP header and the identified QoS flow identifier. As an example, the QoS flow identifier(s) associated with the IP flow(s) may be identified in a QoS Information Element of the link modification request message from 704 of FIG. 7 in an example, whereby UE A provides an indication to UE B of the IP association and the corresponding encapsulation/un-encapsulation protocol (e.g., the indication may be an explicit indication in a PC5-S message, a new QoS Information indicator, or via a new PQI, etc.). In a further example, UE A may define PC5 QoS rule(s) for such encapsulated IP flow(s) to map to the corresponding PC5 QoS Flow IDs (e.g., such rules can be defined as an extension of the PC5 Packet Filter Set as defined in current standards, to facilitate a combined IP and non-IP PC5 Packet Filter). UE A can convey the PC5 QoS rule(s) to UE B (e.g., via the link modification request message of 704), and UE B can create corresponding handling rule(s) (e.g., encapsulation/un-encapsulation) for such traffic. In a specific example, the V2X Layer/ProSe Layer may strip off the non-IP header(s) and pass the embedded IP content (which is now un-encapsulated via the header stripping) to the IP stack.

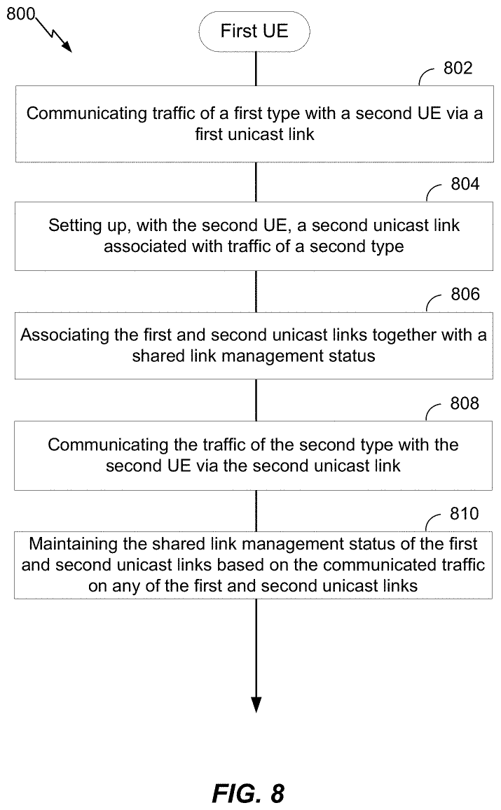

FIG. 8 illustrates a communication process 800 in accordance with another embodiment of the disclosure. The process 800 of FIG. 8 is performed by a first UE, such as UEs 104, 152, 160, 182, 190, any of UEs 240 depicted in FIGS. 2A and 2B, any of UEs 302, 304 in FIG. 3, UE 402 in FIG. 4A, UEs A or B in FIG. 5, etc.). For example, the process 800 may be performed via the sidelink manager 170 in some designs.

Referring to FIG. 8, at 802, the first UE communicates traffic of a first type with a second UE via a unicast link. The traffic of the first type may correspond to non-IP traffic or non-IP traffic. The unicast link in some designs may correspond to a D2D or V2X unicast link, such as PC5 unicast link. The traffic communicated at 802 may comprise traffic transmitted by the first UE to the second UE, traffic transmitted by the second UE to the first UE, or a combination thereof.

Referring to FIG. 8, at 804, the first UE sets up, with the second UE, a second unicast link associated with traffic of a second type. The traffic of the first type may correspond to non-IP traffic or non-IP traffic. At 806, the first UE associates (e.g., binds) the first and second unicast links together with a shared link management status. At 808, the first UE communicates the traffic of the second type with the second UE via the second unicast link. The traffic communicated at 808 may comprise traffic transmitted by the first UE to the second UE, traffic transmitted by the second UE to the first UE, or a combination thereof. At 810, the first UE maintains the shared link management status of the first and second unicast links based on the communicated traffic on any of the first and second unicast links.

Referring to FIG. 8, in an example, 806 may comprise transport of one or more link establishment messages for the second unicast link that include an indication that the first and second unicast links are to be associated (e.g., bound together). For example, the indication the one or more link establishment messages may be transported (i) via session setup signaling resources, or (ii) via the first unicast link.

Referring to FIG. 8, in an example, the shared link management status comprises:
a shared radio link active or failure status,
a shared keep alive timer that triggers transmission, based on inactivity on both the first and second unicast links, of a common keep alive packet to the second UE for extending expiration of both the first and second unicast links,
processing of incoming keep alive packets from the second UE on either of the first and second unicast links for extending expiration of both the first and second unicast links,
shared security information for encryption and/or decryption of data transported over the first and second unicast links, or
any combination thereof.

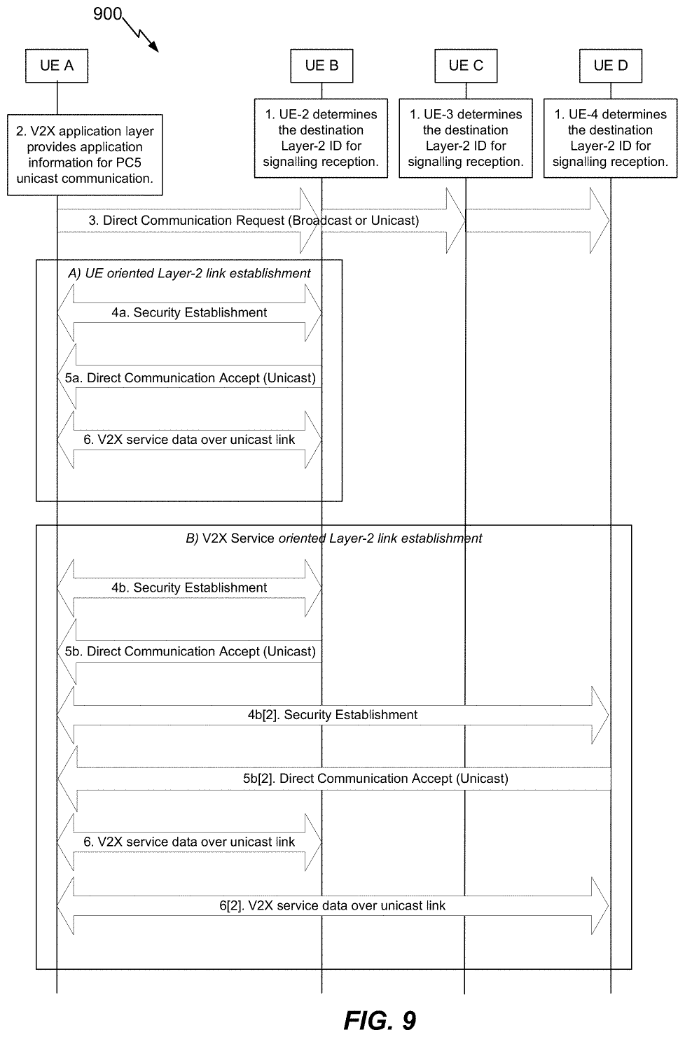

The process 800 of FIG. 8 will now be described in context with an L2 link establishment procedure 900 as depicted in FIG. 9 (e.g., in accordance with 3GPP TS 23.287, clause 6.3.3.1).

Referring to FIG. 9, at (1), UEs B-D each determine a respective destination L2 ID for signaling reception. At (2), a V2X application layer at UE A provides application information for PC5 unicast communication. At (3), UE A transmits a Direct Communication Message (broadcast or unicast) to each of UEs B-D. At (4a), UEs A and B perform Security Establishment. At (5a), UE B transmits a Direct Communication Accept message (unicast) to UE A to establish a first unicast link. At (6), UEs A and B exchange V2X service data over the first unicast link.

Now, assume that UE A or UE B determines to transport a different traffic type (e.g., non-IP traffic if the first unicast link is associated with IP traffic, or IP traffic if the first unicast link is associated with non-IP traffic). At (4b), UEs A and B perform Security Establishment. At (5b), UE B transmits a Direct Communication Accept message (unicast) to UE A to establish a second unicast link. At (4b[2]), UEs A and D perform Security Establishment. At (5b[2]), UE B transmits a Direct Communication Accept message (unicast) to UE A to establish a first unicast link. At (6), UEs A and B exchange V2X service data over the second unicast link. At (6[2]), UEs A and D exchange V2X service data over the second unicast link.

Referring to FIGS. 8-9, in an example, a Direct Communication Request message sent in association with (4b) can be configured to indicate that the second unicast link is to be associated with (e.g., bound to) the first unicast link (e.g., with the same Application Layer ID). In some designs, this indication may correspond to an explicit indicator in the message, or by including an indication in the V2X Service Info, or by an indication in the Security Info element. For example, since the second unicast link is to be associated with (e.g., bound to) the first unicast link, the Security Info may indicate that a previous key set should be reused (e.g., with the same Source User Info, and Target User Info). Such an indication may be also security protected with the existing security information of the existing link. Alternatively, UE A can choose to use the existing PC5 SRB link (i.e., the first unicast link) to send the Link Establishment messages, instead of unprotected messages. In an example, in response to a link request that indicates an association with an existing unicast link, UE B UE may create a new link (e.g., PC5 L2 Link ID and corresponding context), and associate it with the existing link(s) of the same App Layer ID pair (e.g., Source User Info, Target User Info). Alternatively, V2X layer/ProSe layer can inform AS layer of such association when passing the unicast link context down.

Referring to FIGS. 8-9, in an example, the V2X layer/ProSe layer at UEs A-B may share the link management status between the two links, e.g., when a lower layer indication of radio link failure comes, it will apply to both, and when the keep alive signaling (at PC5-S layer) updates the status, it will apply also to both, etc. In some designs, this saves signaling resources. In another example, if the AS layer is enhanced, it may also reduce the sensing operations.

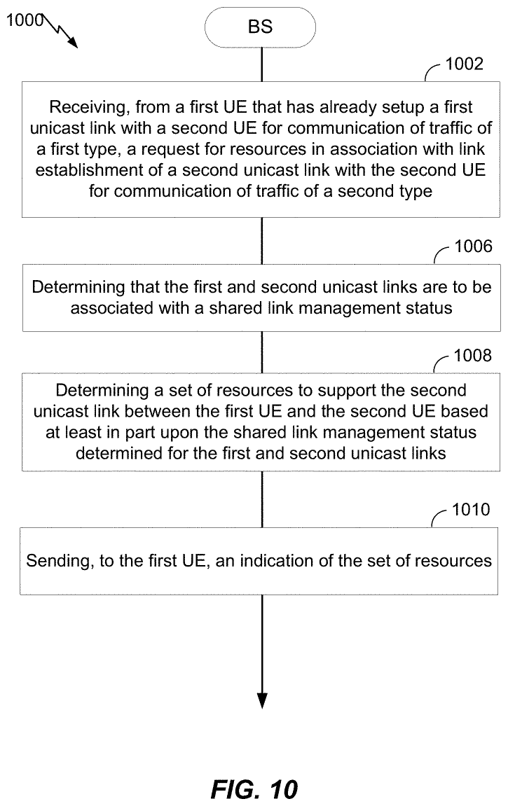

FIG. 10 illustrates a communication process 1000 in accordance with another embodiment of the disclosure. The process 1000 of FIG. 10 is performed by a base station, such as any of the BSs or APs described with respect to FIG. 1, any of eNBs 222-224 of FIGS. 2A-2B, BS 404 of FIG. 4B, etc. For example, the process 1000 may be performed via the sidelink resource manager 176 in some designs. In some designs, the process 1000 may be performed in conjunction with the process 800 of FIG. 8 in a scenario where the resources used for the second unicast link are BS-assigned.

Referring to FIG. 10, at 1002, the BS receives, from a first UE that has already setup a first unicast link (e.g., a PC5 unicast link that supports V2X communication) with a second UE for communication of traffic of a first type, a request for resources in association with link establishment of a second unicast link (e.g., another PC5 unicast link that supports V2X communication) with the second UE for communication of traffic of a second type. The traffic of the first type may correspond to non-IP traffic or non-IP traffic.

Referring to FIG. 10, at 1004, the BS determines that the first and second unicast links are to be associated with (e.g., bound together) with a shared link management status. In some designs, the determination of 1004 can be based upon an indication expressly set forth in the request from 1002. In another example, the determination of 1004 can be implicit (e.g., the BS has knowledge of the existing first unicast link, such that the second unicast link between those same UEs can by implication be bound together).

Referring to FIG. 10, at 1006, the BS determines a set of resources to support the second unicast link between the first UE and the second UE based at least in part upon the shared link management status determined for the first and second unicast links. For example, since the BS knows that the two links are between the same pair of UEs, it will not assign resources for the transmission on the two links at the same time.

Referring to FIG. 10, at 1008, the BS sends, to the first UE, an indication of the set of resources.

Referring to FIG. 10, in an example, the shared link management status comprises:
a shared radio link active or failure status,
a shared keep alive timer that triggers transmission, based on inactivity on both the first and second unicast links, of a common keep alive packet to the second UE for extending expiration of both the first and second unicast links,
processing of incoming keep alive packets from the second UE on either of the first and second unicast links for extending expiration of both the first and second unicast links,
shared security information for encryption and/or decryption of data transported over the first and second unicast links, or
any combination thereof.

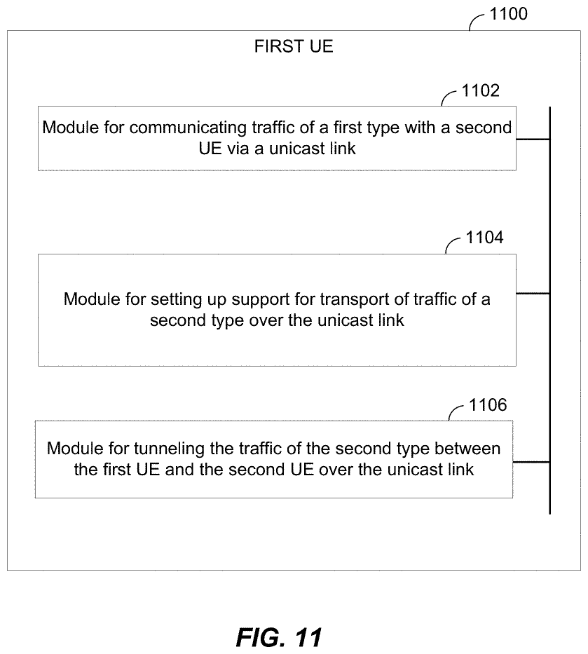

FIG. 11 illustrates an example UE 1100 for implementing the flow 600 of FIG. 6 represented as a series of interrelated functional modules in accordance with an aspect of the disclosure. The UE 1100 may correspond to any of the UEs depicted in FIG. 1, such as UEs 104, 152, 160, 182, 190, any of UEs 240 depicted in FIGS. 2A and 2B, any of UEs 302, 304 in FIG. 3, or UE 400 in FIG. 4A, etc. In the illustrated example, a module for communicating 1102 may correspond at least in some aspects to, for example, a transceiver (e.g., transceiver 410, 420, etc.) as discussed herein. In the illustrated example, a module for setting up 1104 may correspond at least in some aspects to, for example, a processing system (e.g., processing system 432) and/or a transceiver (e.g., transceiver 410, 420, etc.). In the illustrated example, a module for tunneling 1106 may correspond at least in some aspects to, for example, a processing system (e.g., processing system 432) and/or a transceiver (e.g., transceiver 410, 420, etc.).

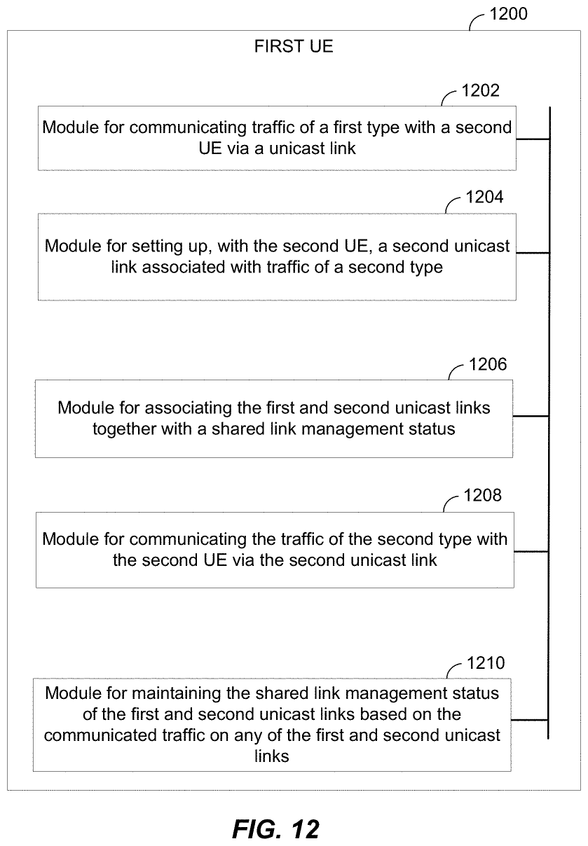

FIG. 12 illustrates an example UE 1200 for implementing the flow 800 of FIG. 8 represented as a series of interrelated functional modules in accordance with an aspect of the disclosure. The UE 1200 may correspond to any of the UEs depicted in FIG. 1, such as UEs 104, 152, 160, 182, 190, any of UEs 240 depicted in FIGS. 2A and 2B, any of UEs 302, 304 in FIG. 3, or UE 400 in FIG. 4A, etc. In the illustrated example, a module for communicating 1202 may correspond at least in some aspects to, for example, a transceiver (e.g., transceiver 410, 420, etc.) as discussed herein. In the illustrated example, a module for setting up 1204 may correspond at least in some aspects to, for example, a processing system (e.g., processing system 432) and/or a transceiver (e.g., transceiver 410, 420, etc.). In the illustrated example, a module for associating 1206 may correspond at least in some aspects to, for example, a processing system (e.g., processing system 432) and/or a transceiver (e.g., transceiver 410, 420, etc.). In the illustrated example, a module for communicating 1208 may correspond at least in some aspects to, for example, a transceiver (e.g., transceiver 410, 420, etc.) as discussed herein. In the illustrated example, a module for maintaining 1210 may correspond at least in some aspects to, for example, a processing system (e.g., processing system 432) and/or a transceiver (e.g., transceiver 410, 420, etc.).

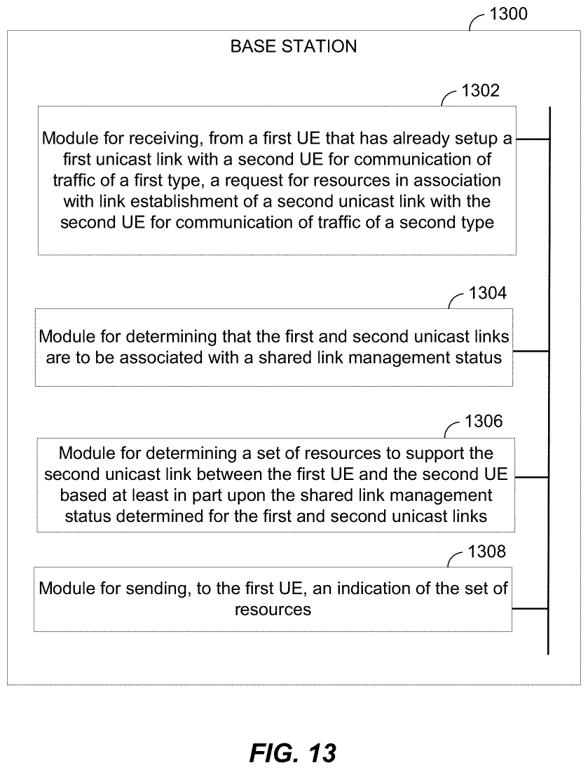

FIG. 13 illustrates an example BS 1300 for implementing the flow 1000 of FIG. 10 represented as a series of interrelated functional modules in accordance with an aspect of the disclosure. The BS 1300 may correspond to any of the BSs or APs described with respect to FIG. 1, any of eNBs 222-224 of FIGS. 2A-2B, BS 404 of FIG. 4B, etc. In the illustrated example, a module for receiving 1302 may correspond at least in some aspects to, for example, a transceiver (e.g., transceiver 450, 460, etc.) as discussed herein. In the illustrated example, a module for determining 1304 may correspond at least in some aspects to, for example, a processing system (e.g., processing system 484) as discussed herein. In the illustrated example, a module for determining 1306 may correspond at least in some aspects to, for example, a processing system (e.g., processing system 484) as discussed herein. In the illustrated example, a module for sending 1308 may correspond at least in some aspects to, for example, a transceiver (e.g., transceiver 450, 460, etc.) as discussed herein.

The functionality of the modules of FIGS. 11-13 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 11-13, as well as other components and functions described herein, may be implemented using any suitable means. Such means also may be implemented, at least in part, using corresponding structure as taught herein. For example, the components described above in conjunction with the “module for” components of FIGS. 11-13 also may correspond to similarly designated “means for” functionality. Thus, in some aspects one or more of such means may be implemented using one or more of processor components, integrated circuits, or other suitable structure as taught herein, including as an algorithm. One skilled in the art will recognize in this disclosure an algorithm represented in the prose described above, as well as in sequences of actions that may be represented by pseudocode. For example, the components and functions represented by FIGS. 11-13 may include code for performing a LOAD operation, a COMPARE operation, a RETURN operation, an IF-THEN-ELSE loop, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of operating a first user equipment (UE), comprising:
communicating traffic of a first type with a second UE via a unicast link;
setting up support for transport of traffic of a second type over the unicast link; and
tunneling the traffic of the second type between the first UE and the second UE over the unicast link.

2. The method of claim 1, wherein the traffic of the first type corresponds to Internet Protocol (IP) traffic and the traffic of the second type corresponds to non-IP traffic.

3. The method of claim 2,
wherein the setting up comprises:
identifying a Quality of Service (QoS) flow identifier for transport of the non-IP traffic over the unicast link, and
wherein the tunneling comprises:
encapsulating a first subset of the non-IP traffic for transmission from the first UE to the second UE over the unicast link, the encapsulated first subset being associated with the identified QoS flow identifier, and
un-encapsulating a second subset of the non-IP traffic received at the first UE from the second UE over the unicast link in association with the identified QoS flow identifier, the second subset being associated with the identified QoS flow identifier.

4. The method of claim 2,
wherein the setting up further comprises identifying a port for transport of the non-IP traffic over the unicast link,
wherein the encapsulated first subset is further transmitted over the unicast link with the identified port, and
wherein the un-encapsulated second subset is further transmitted over the unicast link with the identified port.

5. The method of claim 1, wherein the traffic of the first type corresponds to non-IP traffic and the traffic of the second type corresponds to IP traffic.

6. The method of claim 5,
wherein the setting up comprises:
identifying a non-IP header to be used for transport of the IP traffic over the unicast link, and
identifying a Quality of Service (QoS) flow identifier for transport of the IP traffic over the unicast link, and
wherein the tunneling comprises:
encapsulating a first subset of the IP traffic for transmission from the first UE to the second UE over the unicast link, the encapsulated first subset being associated with the identified non-IP header and the identified QoS flow identifier, and
un-encapsulating a second subset of the IP traffic received at the first UE from the second UE over the unicast link, the second subset being associated with the identified non-IP header and the identified QoS flow identifier.

7. The method of claim 6,
wherein the identified non-IP header is pre-defined, or
wherein the identified non-IP header is dynamically negotiated between the first and second UEs.

8. The method of claim 1, wherein, at an application-layer, the traffic of the first type and the traffic of the second type are associated with the same application-layer identifier.

9. The method of claim 1, wherein the unicast link corresponds to a PC5 unicast link that supports vehicle-to-X (V2X) communication.

10. A method of operating a first user equipment (UE), comprising:
communicating traffic of a first type with a second UE via a first unicast link;
setting up, with the second UE, a second unicast link associated with traffic of a second type;
associating the first and second unicast links together with a shared link management status;
communicating the traffic of the second type with the second UE via the second unicast link; and
maintaining the shared link management status of the first and second unicast links based on the communicated traffic on any of the first and second unicast links.

11. The method of claim 10, wherein the associating comprises:
transporting one or more link establishment messages for the second unicast link that include an indication that the first and second unicast links are to be associated with the shared link management status.

12. The method of claim 11, wherein the one or more link establishment messages are transported (i) via session setup signaling resources, or (ii) via the first unicast link.

13. The method of claim 10, wherein the shared link management status comprises:
a shared radio link active or failure status,
a shared keep alive timer that triggers transmission, by the first UE based on inactivity on both the first and second unicast links, of a common keep alive packet to the second UE for extending expiration of both the first and second unicast links,
processing of incoming keep alive packets from the second UE on the first unicast link or the second unicast link for extending expiration of both the first and second unicast links,
shared security information for encryption and/or decryption of data transported over the first and second unicast links, or
any combination thereof.

14. The method of claim 10, wherein the traffic of the first type corresponds to Internet Protocol (IP) traffic and the traffic of the second type corresponds to non-IP traffic.

15. The method of claim 10, wherein the traffic of the first type corresponds to non-IP traffic and the traffic of the second type corresponds to IP traffic.

16. The method of claim 10, wherein the first and second unicast links each correspond to a PC5 unicast link that supports vehicle-to-X (V2X) communication.

17. A method of operating a network component, comprising:
receiving, from a first user equipment (UE) that has already setup a first unicast link with a second UE for communication of traffic of a first type, a request for resources in association with link establishment of a second unicast link with the second UE for communication of traffic of a second type;
determining that the first and second unicast links are to be associated with a shared link management status;
determining a set of resources to support the second unicast link between the first UE and the second UE based at least in part on the shared link management status determined for the first and second unicast links; and
sending, to the first UE, an indication of the set of resources.

18. The method of claim 17, wherein the shared link management status comprises:
a shared radio link active or failure status,
a shared keep alive timer that triggers transmission, by the first UE based on inactivity on both the first and second unicast links, of a common keep alive packet to the second UE for extending expiration of both the first and second unicast links,
processing of incoming keep alive packets from the second UE on the first unicast link or the second unicast link for extending expiration of both the first and second unicast links,
shared security information for encryption and/or decryption of data transported over the first and second unicast links, or
any combination thereof.

19. The method of claim 17, wherein the traffic of the first type corresponds to Internet Protocol (IP) traffic and the traffic of the second type corresponds to non-IP traffic.

20. The method of claim 17, wherein the traffic of the first type corresponds to non-IP traffic and the traffic of the second type corresponds to IP traffic.

21. The method of claim 17, wherein the first and second unicast links each correspond to a PC5 unicast link that supports vehicle-to-X (V2X) communication.

22. A first user equipment (UE), comprising:
a memory;
at least one transceiver; and
at least one processor coupled to the memory and the at least one transceiver, the at least one processor configured to:
communicate traffic of a first type with a second UE via a unicast link;
setup support for transport of traffic of a second type over the unicast link; and
tunnel the traffic of the second type between the first UE and the second UE over the unicast link.

23. A first user equipment (UE), comprising:
a memory;
at least one transceiver; and
at least one processor coupled to the memory and the at least one transceiver, the at least one processor configured to:
communicate traffic of a first type with a second UE via a first unicast link;
setup, with the second UE, a second unicast link associated with traffic of a second type;
associate the first and second unicast links together with a shared link management status;
communicate the traffic of the second type with the second UE via the second unicast link; and
maintain the shared link management status of the first and second unicast links based on the communicated traffic on any of the first and second unicast links.

24. A network component, comprising:
a memory;
at least one transceiver; and
at least one processor coupled to the memory and the at least one transceiver, the at least one processor configured to:
receive, from a first user equipment (UE) that has already setup a first unicast link with a second UE for communication of traffic of a first type, a request for resources in association with link establishment of a second unicast link with the second UE for communication of traffic of a second type;
determine that the first and second unicast links are to be associated with a shared link management status;
determine a set of resources to support the second unicast link between the first UE and the second UE based at least in part on the shared link management status determined for the first and second unicast links; and
send, to the first UE, an indication of the set of resources.

25.-30. (canceled)

31. The method of claim 2, wherein the non-IP traffic comprises a PC5 packet filter.

32. The first UE of claim 22, wherein the traffic of the first type corresponds to Internet Protocol (IP) traffic and the traffic of the second type corresponds to non-IP traffic.

33. The first UE of claim 32, wherein the non-IP traffic comprises a PC5 packet filter.

34. The first UE of claim 32,
wherein the at least one processor is configured to setup the support for the traffic of the second type by:
identifying a Quality of Service (QoS) flow identifier for transport of the non-IP traffic over the unicast link, and
wherein the at least one processor is configured to tunnel the traffic of the second type by:
encapsulating a first subset of the non-IP traffic for transmission from the first UE to the second UE over the unicast link, the encapsulated first subset being associated with the identified QoS flow identifier, and
un-encapsulating a second subset of the non-IP traffic received at the first UE from the second UE over the unicast link in association with the identified QoS flow identifier, the second subset being associated with the identified QoS flow identifier.

35. The first UE of claim 32,
wherein the at least one processor is configured to setup the support for the traffic of the second type by identifying a port for transport of the non-IP traffic over the unicast link,
wherein the encapsulated first subset is further transmitted over the unicast link with the identified port, and
wherein the un-encapsulated second subset is further transmitted over the unicast link with the identified port.

36. The first UE of claim 22, wherein the traffic of the first type corresponds to non-IP traffic and the traffic of the second type corresponds to IP traffic.

37. The first UE of claim 36,
wherein the at least one processor is configured to setup the support for the traffic of the second type by:
identifying a non-IP header to be used for transport of the IP traffic over the unicast link, and
identifying a Quality of Service (QoS) flow identifier for transport of the IP traffic over the unicast link, and
wherein the at least one processor is configured to tunnel the traffic of the second type by:
encapsulating a first subset of the IP traffic for transmission from the first UE to the second UE over the unicast link, the encapsulated first subset being associated with the identified non-IP header and the identified QoS flow identifier, and
un-encapsulating a second subset of the IP traffic received at the first UE from the second UE over the unicast link, the second subset being associated with the identified non-IP header and the identified QoS flow identifier.

38. The first UE of claim 37,
wherein the identified non-IP header is pre-defined, or
wherein the identified non-IP header is dynamically negotiated between the first and second UEs.

39. The first UE of claim 22, wherein, at an application-layer, the traffic of the first type and the traffic of the second type are associated with the same application-layer identifier.

40. The first UE of claim 22, wherein the unicast link corresponds to a PC5 unicast link that supports vehicle-to-X (V2X) communication.

41. The first UE of claim 23,
wherein the at least one processor is configured to associate the first and second unicast links together with the shared link management status by:
transporting one or more link establishment messages for the second unicast link that include an indication that the first and second unicast links are to be associated with the shared link management status.

42. The first UE of claim 41, wherein the one or more link establishment messages are transported (i) via session setup signaling resources, or (ii) via the first unicast link.

43. The first UE of claim 23, wherein the shared link management status comprises:
a shared radio link active or failure status,
a shared keep alive timer that triggers transmission, based on inactivity on both the first and second unicast links, of a common keep alive packet to the second UE for extending expiration of both the first and second unicast links,
processing of incoming keep alive packets from the second UE on the first unicast link or the second unicast link for extending expiration of both the first and second unicast links,
shared security information for encryption and/or decryption of data transported over the first and second unicast links, or
any combination thereof.

44. The first UE of claim 23, wherein the traffic of the first type corresponds to Internet Protocol (IP) traffic and the traffic of the second type corresponds to non-IP traffic.

45. The first UE of claim 23, wherein the traffic of the first type corresponds to non-IP traffic and the traffic of the second type corresponds to IP traffic.

46. The first UE of claim 23, wherein the first and second unicast links each correspond to a PC5 unicast link that supports vehicle-to-X (V2X) communication.

47. The network component of claim 24, wherein the shared link management status comprises:
a shared radio link active or failure status,
a shared keep alive timer that triggers transmission, based on inactivity on both the first and second unicast links, of a common keep alive packet to the second UE for extending expiration of both the first and second unicast links,
processing of incoming keep alive packets from the second UE on the first unicast link or second unicast link for extending expiration of both the first and second unicast links,
shared security information for encryption and/or decryption of data transported over the first and second unicast links, or
any combination thereof.

48. The network component of claim 24, wherein the traffic of the first type corresponds to Internet Protocol (IP) traffic and the traffic of the second type corresponds to non-IP traffic.

49. The network component of claim 24, wherein the traffic of the first type corresponds to non-IP traffic and the traffic of the second type corresponds to IP traffic.

50. The network component of claim 24, wherein the first and second unicast links each correspond to a PC5 unicast link that supports vehicle-to-X (V2X) communication.
